(19) United States
(12) Patent Application Publication
(10) Pub. No.: US 2017/0351424 A1
(43) Pub. Date: Dec. 7, 2017

(54) Data Processing Device and Display Method Thereof

(71) Applicant: Semiconductor Energy Laboratory Co., Ltd., Kanagawa-ken (JP)

(72) Inventor: Suguru Murata, Ebina (JP)

(73) Assignee: Semiconductor Energy Laboratory Co., Ltd., Kanagawa-ken (JP)

(21) Appl. No.: 15/609,434

(22) Filed: May 31, 2017

(30) Foreign Application Priority Data
Jun. 3, 2016 (JP) 2016-111951

(51) Int. Cl. G06F 3/0488; G06F 3/041; G06F 3/0481; G06F 3/0484

(52) U.S. Cl. CPC G06F 3/04883; G06F 3/04842; G06F 3/0412; G06F 3/0481

(57) ABSTRACT

A novel display method with high operability is provided. A data processing device includes a display portion, an input portion, an arithmetic portion, and a memory portion. The input portion has a function of detecting a first contact point and a second contact point and a function of detecting a first path of the second contact point when the second contact point moves while the first contact point is fixed. The arithmetic portion has a function of storing, in the memory portion, data displayed on a region of the display portion where the first path is detected. The input portion has a function of detecting a third contact point and a fourth contact point after detecting the first path, and detecting a second path of the fourth contact point when the fourth contact point moves while the third contact point is fixed. The arithmetic portion has a function of pasting the data stored in the memory portion on a region where the second path is detected.

### TECHNICAL FIELD

One embodiment of the present invention relates to a display device, an input/output device, a data processing device, a display method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

### BACKGROUND ART

A data processing device with a touch panel can operate data or images, which are displayed on a display, by detecting the coordinates and the path input by more than one fingers or the like. A method for selecting data or images displayed on a display by touching a touch panel with fingers and deleting or enlarging the selected data or image by moving the fingers up and down or left and right is proposed (see Patent Document 1).

### REFERENCE

### [Patent Document 1] Japanese Published Patent Application No. 2001-290585

### DISCLOSURE OF INVENTION

An object of one embodiment of the present invention is to provide a novel data processing device with excellent operability. Another object is to provide a novel data processing device with highly reliable operation. Another object is to provide a novel display method with excellent operability. Another object is to provide a novel display method with highly reliable operation. Another object is to provide a novel display device, a novel input/output device, a novel data processing device, a novel display method, or a novel semiconductor device.

Note that the description of these objects does not preclude the existence of other objects. In one embodiment of the present invention, there is no need to achieve all the objects. Other objects will be apparent from and can be derived from the description of the specification, the drawings, the claims, and the like.

One embodiment of the present invention is a data processing device including a display portion, an input portion, an arithmetic portion, and a memory portion. The input portion has a function of detecting a first contact point and a second contact point, and a function of detecting a first path of the second contact point when the second contact point moves while the first contact point is fixed. The arithmetic portion has a function of storing, in the memory portion, data displayed on a region of the display portion where the first path is detected. The input portion has a function of detecting a third contact point and a fourth contact point after detecting the first path, and a function of detecting a second path of the fourth contact point when the fourth contact point moves while the third contact point is fixed. The arithmetic portion has a function of pasting the data stored in the memory portion on a region where the second path is detected.

Another embodiment of the present invention is a data processing device including a display portion, an input portion, an arithmetic portion, and a memory portion. The input portion has a function of detecting a first contact point and a second contact point, and a function of detecting a first path of the second contact point when the second contact point moves while the first contact point is fixed. The arithmetic portion has a function of displaying a first pop-up window near the first path on the display portion. The input portion has a function of detecting a contact point on the first pop-up window. The arithmetic portion has a function of storing, in the memory portion, data displayed on a region where the first path is detected, in accordance with data selected by the contact point on the first pop-up window. The arithmetic portion has a function of closing the first pop-up window on the display portion. The input portion has a function of detecting a third contact point and a fourth contact point after detecting the first path, and a function of detecting a second path of the fourth contact point when the fourth contact point moves while the third contact point is fixed. The arithmetic portion has a function of displaying a second pop-up window near the second path on the display portion. The input portion has a function of detecting a contact point on the second pop-up window. The arithmetic portion has a function of pasting the data stored in the memory portion on a region where the second path is detected, in accordance with data selected by the contact point on the second pop-up window. The arithmetic portion has a function of closing the second pop-up window on the display portion.

The display portion may include a first display element and a second display element. The first display element may be a reflective liquid crystal element, and the second display element may be a light-emitting element. The second display element may display the first pop-up window and the second pop-up window. The input portion may be a touch panel.

Another embodiment of the present invention is a display method of a data processing device, including: a first step of detecting a first contact point and a second contact point; a second step of detecting a first path of the second contact point when the second contact point moves while the first contact point is fixed; a third step of displaying a first pop-up window near a region where the first path is detected; a fourth step of detecting a contact point on the first pop-up window; a fifth step of storing, in a memory portion, data displayed on a region where the first path is detected, in accordance with data selected by the contact point on the first pop-up window; a sixth step of detecting a third contact point and a fourth contact point; a seventh step of detecting a second path of the fourth contact point when the fourth contact point moves while the third contact point is fixed; an eighth step of displaying a second pop-up window near the second path; a ninth step of detecting a contact point on the second pop-up window; and a tenth step of pasting the data on a region where the second path is detected, in accordance with data selected by the contact point on the second pop-up window.

Although the block diagram attached to this specification shows components classified by their functions in independent blocks, it is difficult to classify actual components according to their functions completely and it is possible for one component to have two or more functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification, although connection relation of the transistor is described assuming that the source and the drain are fixed for convenience in some cases, actually, the names of the source and the drain interchange with each other depending on the relation of the potentials.

In this specification, a “source” of a transistor means a source region that is part of a semiconductor film functioning as an active layer or a source electrode connected to the semiconductor film. Similarly, a “drain” of a transistor means a drain region that is part of the semiconductor film or a drain electrode connected to the semiconductor film. A “gate” means a gate electrode.

In this specification, a state in which transistors are connected in series means, for example, a state in which only one of a source and a drain of a first transistor is connected to only one of a source and a drain of a second transistor. A state in which transistors are connected in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, connection means not only direct connection but also indirect connection through a circuit element such as a wiring, a resistor, a diode, or a transistor so that current, voltage, or a potential can be supplied or transmitted.

In this specification, even when different components are connected to each other in a circuit diagram, there is actually a case where one conductive film has functions of two or more components such as a case where part of a wiring serves as an electrode. The term “connection” in this specification also means such a case where one conductive film has functions of two or more components.

In this specification, one of a first electrode and a second electrode of a transistor refers to a source electrode and the other refers to a drain electrode.

According to one embodiment of the present invention, a novel data processing device with excellent operability, a novel data processing device with highly reliable operation, a novel display method with easy operation, a novel display method with highly reliable operation, a novel input/output device, a novel data processing device, a novel display method, or a novel semiconductor device can be provided.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF DRAWINGS

In the accompanying drawings:

FIG. 1 is a flow chart showing a method for driving a data processing device of one embodiment;

FIGS. 2A to 2C are drawings illustrating a method for driving a data processing device of one embodiment;

FIGS. 3A and 3B are a flow chart and a drawing showing a method for driving a data processing device of one embodiment;

FIGS. 4A and 4B are a flow chart and a drawing showing a method for driving a data processing device of one embodiment;

FIGS. 5A to 5D are a flow chart and drawings showing a method for driving a data processing device of one embodiment;

FIG. 6 is a flow chart showing a method for driving a data processing device of one embodiment;

FIGS. 7A to 7C are a block diagram and projection views illustrating the structure of a data processing device of one embodiment;

FIG. 8 is a block diagram illustrating the structure of an input portion that can be used for an input/output device of one embodiment;

FIGS. 9A, 9B1, 9B2, and 9C illustrate the structure of an input/output panel that can be used for an input/output device of one embodiment;

FIGS. 10A and 10B are cross-sectional views illustrating the structure of a display panel that can be used in a display device of one embodiment;

FIGS. 11A and 11B are cross-sectional views illustrating the structure of a display panel that can be used in a display device of one embodiment;

FIGS. 12A and 12B are bottom views illustrating the structure of a display panel that can be used in a display device of one embodiment;

FIG. 13 is a circuit diagram illustrating a pixel circuit of a display panel that can be used in a display device of one embodiment;

FIGS. 14A to 14C are schematic views illustrating the shape of reflective films in pixels that can be used in a display device of one embodiment; and

FIGS. 15A to 15H are drawings each illustrating the structure of an electronic device of one embodiment.

### BEST MODE FOR CARRYING OUT THE INVENTION

Embodiments will be described in detail with reference to the drawings. However, the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the present invention described below, the same portions or portions having similar functions are denoted by the same reference numerals in different drawings, and a description thereof is not repeated.

### Embodiment 1

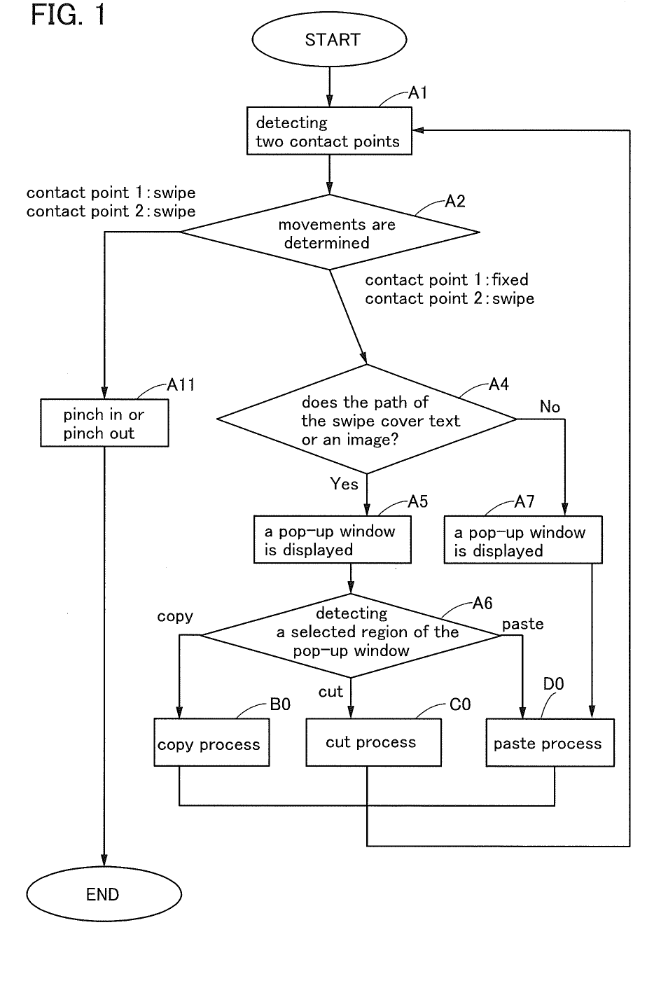

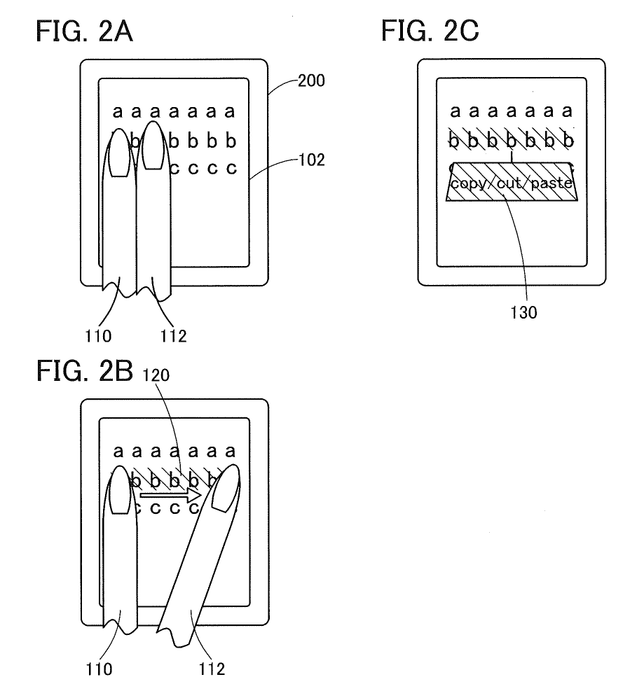

In this embodiment, the structure of a data processing device of one embodiment of the present invention and a method for displaying data will be described with reference to FIG. 1, FIGS. 2A to 2C, FIGS. 3A and 3B, FIGS. 4A and 4B, FIGS. 5A to 5D, FIG. 6, and FIGS. 7A to 7C.

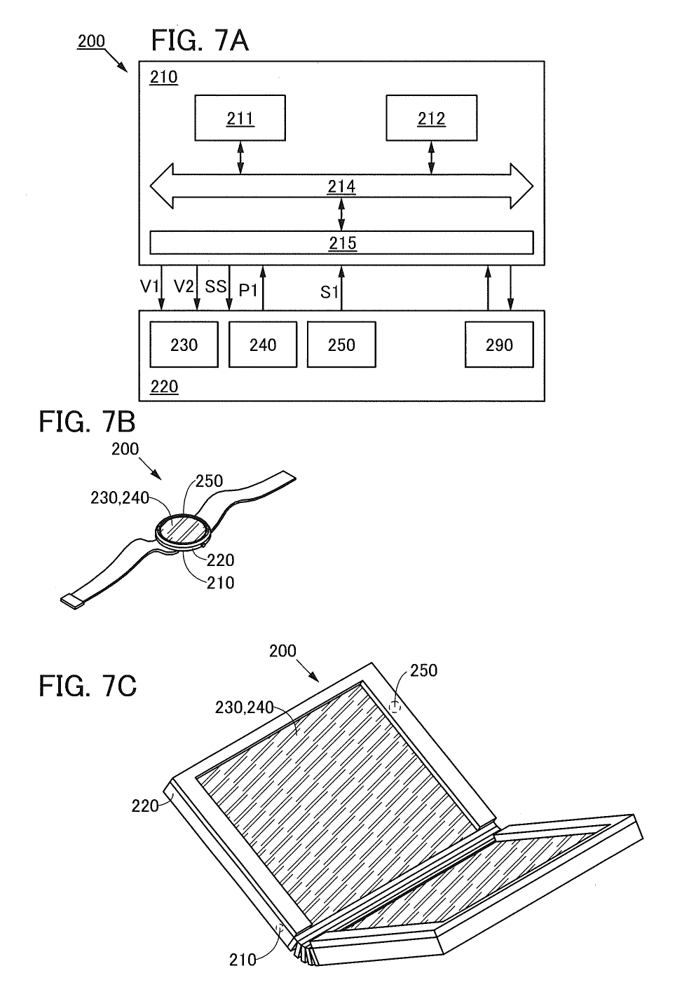

FIG. 7A is a block diagram illustrating the structure of the data processing device of one embodiment of the present invention. FIGS. 7B and 7C are projection views each illustrating an example of the external view of a data processing device 200.

### Structure Example 1 of Data Processing Device

The data processing device 200 described in this embodiment includes an input/output device 220 and an arithmetic device 210 (see FIG. 7A). The input/output device 220 is electrically connected to the arithmetic device 210. The data processing device 200 can include a housing (see FIG. 7B or 7C).

The input/output device 220 includes a display portion 230 and an input portion 240 (see FIG. 7A). The input/output device 220 also includes a sensor portion 250. The input/output device 220 can include a communication portion 290.

The input/output device 220 has a function of receiving data V1 and V2 or control data SS, and a function of supplying positional data P1 or sensing data S1.

The arithmetic device 210 has a function of receiving the positional data P1 or the sensing data S1. The arithmetic device 210 has a function of supplying the data V1 and V2. The arithmetic device 210 has a function of operating on the basis of the positional data P1 or the sensing data S1, for example.

The housing has a function of storing the input/output device 220 or the arithmetic device 210. Alternatively, the housing has a function of supporting the display portion 230 or the arithmetic device 210.

The display portion 230 has a function of displaying data on the basis of the data V1. The display portion 230 has a function of displaying data on the basis of the data V2. The display portion 230 has a function of displaying data on the basis of the control data SS. Note that the data displayed on the display portion 230 include text data, image data, and the like.

The input portion 240 has a function of supplying the positional data P1. The positional data P1 includes display coordinates and data displayed at the coordinates.

The sensor portion 250 has a function of supplying the sensing data S1. The sensor portion 250 has a function of sensing the illuminance of an environment where the data processing device 200 is used and a function of supplying illuminance data, for example. The sensor portion 250 has a function of sensing the chromaticity of ambient light in the environment where the data processing device 200 is used and a function of supplying illuminance data, for example.

Thus, the data processing device can identify the intensity of light received by the housing of the data processing device and operate under the usage environment. For example, the data processing device can control the illuminance of the display portion 230 in accordance with the brightness of the usage environment, whereby the power consumption of the data processing device can be controlled and its visibility can be improved.

Individual components included in the data processing device will be described below. Note that these components cannot be clearly distinguished and one component may also serve as another component or include part of another component. For example, a touch panel in which a touch sensor is provided so as to overlap with a display panel serves as an input portion as well as a display portion.

### <<Arithmetic Device 210>>

The arithmetic device 210 includes an arithmetic portion 211 and a memory portion 212. The arithmetic device 210 also includes a transmission path 214 and an input/output interface 215.

### <<Arithmetic Portion 211>>

The arithmetic portion 211 has a function of displaying data on the display portion 230. The arithmetic portion 211 also has a function of storing data, which is acquired by the input portion 240, in the memory portion 212. In addition, the arithmetic portion 211 has a function of executing software (program).

### <<Memory Portion 212>>

The memory portion 212 has a function of storing the program executed by the arithmetic portion 211, for example, initial data, setting data, an image, or the like. The memory portion 212 also has a function of storing the positional data acquired by the input portion 240.

Specifically, a hard disk, a flash memory, a memory including a transistor including an oxide semiconductor, or the like can be used for the memory portion 212.

### <<Input/Output Interface 215 and Transmission Path 214>>

The input/output interface 215 includes a terminal or a wiring and has a function of supplying and receiving data. The input/output interface 215 can be electrically connected to the transmission path 214 and the input/output device 220, for example.

The transmission path 214 includes a wiring and has a function of supplying and receiving data. The transmission path 214 can be electrically connected to the arithmetic portion 211, the memory portion 212, or the input/output interface 215, for example.

### <<Input/Output Device 220>>

The input/output device 220 includes the display portion 230, the input portion 240, the sensor portion 250, or the communication portion 290.

### <<Display Portion 230>>

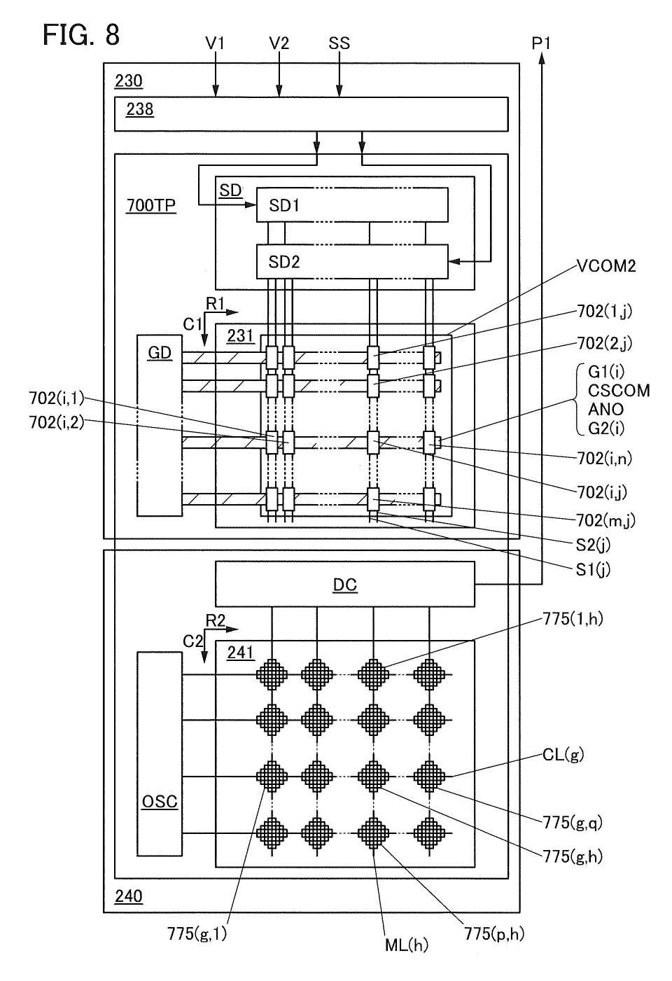

The display portion 230 includes a control portion 238, a driver circuit GD, a driver circuit SD, and part of an input/output panel 700TP (see FIG. 8).

### <<Input Portion 240>>

Any of a variety of human interfaces or the like can be used for the input portion 240 (see FIGS. 7A to 7C).

For example, a touch sensor having a region overlapping with the display portion 230 can be used for the input portion 240. An input/output device that includes the display portion 230 and a touch sensor having a region overlapping with the display portion 230 can be referred to as a touch panel or a touch screen.

A user can make various gestures (e.g., tap, drag, swipe, and pinch in) using his/her finger as a pointer on the touch panel, for example.

The arithmetic device 210, for example, analyzes data of the position, path, or the like of the finger on the touch panel and determines that a specific gesture is supplied when the analysis results meet predetermined conditions. Thus, the user can supply a predetermined operation instruction associated with a predetermined gesture by using the gesture.

For instance, the user can supply a “scroll instruction” for changing the portion where data is displayed by using a gesture of touching and moving his/her finger on the touch panel.

### <<Sensor Portion 250>>

The sensor portion 250 has a function of sensing the ambient conditions and supplying the sensing data. Specifically, the sensor portion 250 can supply illuminance data, attitude data, pressure data, positional data, and the like.

A photosensor, an attitude sensor, an acceleration sensor, a direction sensor, a global positioning system (GPS) signal receiving circuit, a pressure sensor, a temperature sensor, a humidity sensor, a camera, or the like, for example, can be used as the sensor portion 250.

### <<Communication Portion 290>>

The communication portion 290 has a function of supplying and obtaining data to/from a network.

### <<Method 1 for Processing Display Data>>

Next, a method for processing display data of one embodiment of the present invention will be described. The method is excellent in operability and has high operational reliability. Here, operations such as selection, copy, cut, and paste of display data will be described. FIG. 1, FIGS. 2A to 2C, FIGS. 3A and 3B, FIGS. 4A and 4B, and FIGS. 5A to 5D are flow charts showing embodiments of a method for processing display data and the display examples. Note that FIGS. 2A to 2C, FIG. 3B, FIG. 4B, and FIGS. 5B to 5D are drawings illustrating operation methods of the display portion 102 in the data processing device 200.

As shown in FIG. 1, the input portion detects two contact points in Step A1. For example, as shown in FIG. 2A, the touch panel senses two contact points when a forefinger 110 and a middle finger 112 touch the touch panel provided over the display portion 102.

Then, movements of the two contact points are determined in Step A2. When one of the two contact points is fixed and the other slides on the display portion 102 (such movement is also referred to as swipe), the process goes to Step A4. For example, when the middle finger 112 moves in a direction indicated by an arrow while the forefinger 110 is fixed as shown in FIG. 2B, the process goes to Step A4.

At this time, it is preferable that the path of the swipe be indicated by a marker 120, whereby the selected data can be highlighted.

With one of the two contact points fixed and the other swiping, data in a certain region can be selected easily and accurately. As a result, the operability and operational reliability of the data processing device can be improved.

When each of the two contact points slides on a screen of the display portion (swipe) in Step A2, the process goes to Step A11. For example, when the forefinger slides leftward while the middle finger slides rightward, the process goes to Step A11. In Step A11, the display data is zoomed in or out (such operation is also referred to as pinch in or pinch out) in accordance with the movements of the two contact points. Then, when the swipe is stopped, the zooming in or out of the display data is also stopped.

In the case where a region corresponding to the path of the swipe (hereinafter referred to as a selected region) is determined to cover text or an image in Step A4, the process goes to Step A5.

In Step A5, the positional data of the selected region and data displayed on the selected region are acquired. In addition, a pop-up window (a region 130 in FIG. 2C) that includes operation options such as “copy”, “cut”, and “paste” is displayed.

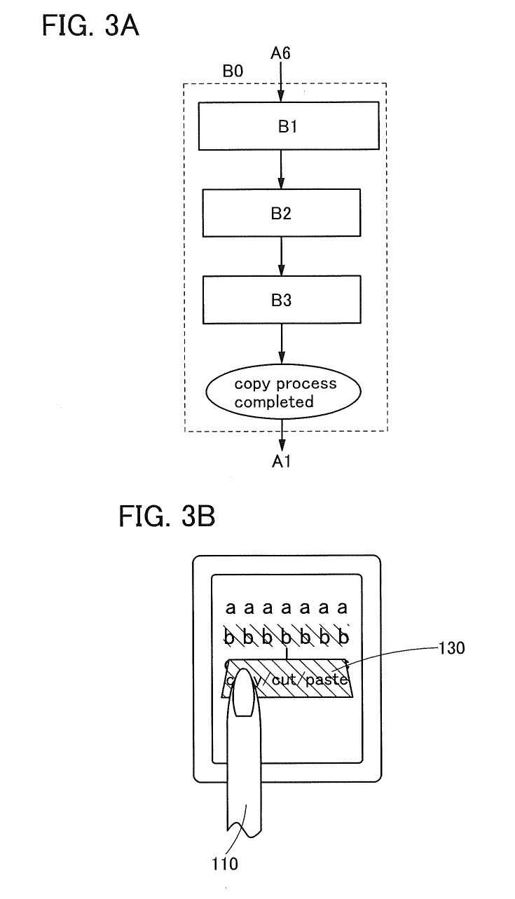

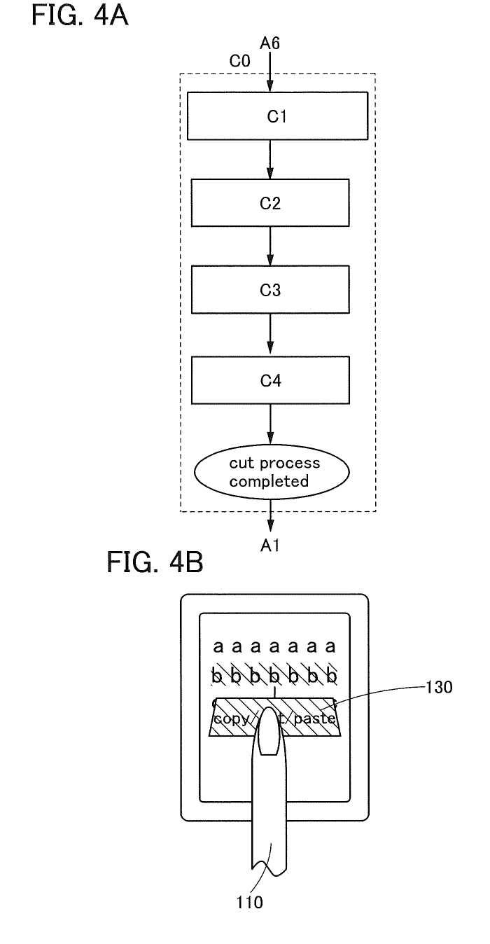

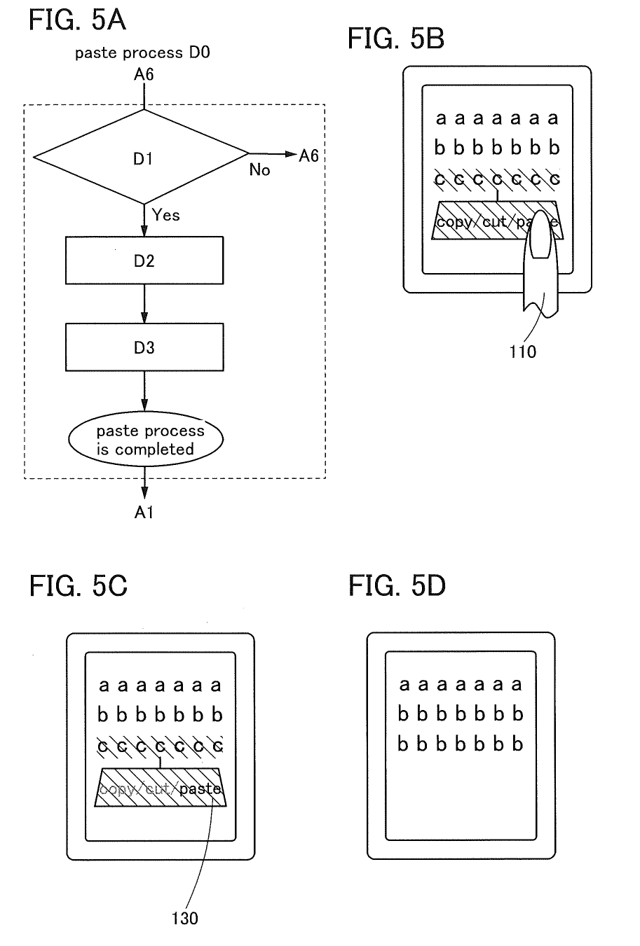

Then, when a user selects one operation from the options displayed on the pop-up window, the input portion detects the position that is selected on the pop-up window. In the case where the contact point of the forefinger 110 corresponds to “copy” as shown in FIG. 3B, for example, the process goes to a copy process shown in Step B0. In the case where the contact point of the forefinger 110 corresponds to “cut” as shown in FIG. 4B, the process goes to a cut process shown in Step C0. In the case where the contact point of the forefinger 110 corresponds to “paste” as shown in FIG. 5B, the process goes to a paste process shown in Step D0.

### <<Copy Process B0>>

As shown in FIG. 3A, in the copy process B0, the data displayed on the selected region is stored in the memory portion in Step B1.

Then, the pop-up window is closed in Step B2.

Subsequently, a “copied” flag is set in the memory portion in Step B3.

Through the above steps, the copy process B0 is completed. Then, the process goes to Step A1 in FIG. 1.

### <<Cut Process C0>>

In the cut process C0, the data displayed on the selected region is stored in the memory portion in Step C1.

Then, the data displayed on the selected region is deleted in Step C2.

Subsequently, the pop-up window is closed in Step C3.

Subsequently, a “copied” flag is set in the memory portion in Step C4.

Through the above steps, the cut process C0 is completed. Then, the process goes to Step A1 in FIG. 1.

### <<Paste Process D0>>

In the paste process D0, whether or not the “copied” flag is set in the memory portion is determined in Step D1. In the case where the “copied” flag is set, the process goes to Step D2. In the case where the “copied” flag is not set, the process goes to Step A6 in FIG. 1.

Then, the data stored in the memory portion is pasted on (written over) the selected region in Step D2.

Subsequently, the pop-up window is closed in Step D3 (see FIG. 5D).

Through the above steps, the paste process is completed. Then, the process goes to Step A1 in FIG. 1.

In the case where the region corresponding to the path of the swipe (selected region) is determined not to cover text or an image in Step A4, the process goes to Step A7.

In Step A7, a pop-up window (a region 130 in FIG. 5C) that includes the operation option “paste” is displayed.

Then, the input portion detects the position that is selected on the pop-up window. In the case where the selected position corresponds to “paste” as shown in FIG. 5C, the process goes to the paste process shown in Step D0.

Through the above steps, data in a certain region can be selected easily and accurately. In addition, operations such as “copy”, “cut”, and “paste” of the selected data can be easily performed. Thus, this embodiment can improve the operability and operational reliability of the data processing device. The variety of operations of the data processing device can also be increased.

### <<Method 2 for Processing Display Data>>

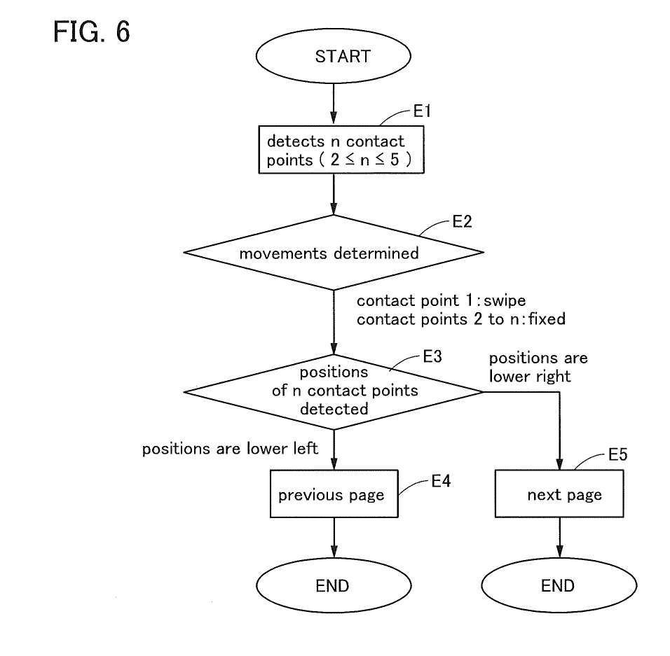

Next, a method for processing display data of another embodiment of the present invention will be described. The method is excellent in operability and has high operational reliability. Here, an operation of turning a page will be described. FIG. 6 is a flow chart showing an embodiment of a method for processing display data.

As shown in FIG. 6, the input portion detects n (2≦n≦5) contact points in Step E1.

Then, movements of the n contact points are determined in Step E2. When the second to n-th contact points are fixed and the first contact point slides on the display portion (swipe), the process goes to Step E3.

Then, the positions of n contact points on the display portion are detected. In the case where the positions of the contact points are lower left of the display portion, the process goes to Step E4 and the display data is replaced with data of the previous page. Then, the process is completed.

In the case where the positions of the contact points are lower right of the display portion, the process goes to Step E5 and the display data is replaced with data of the next page. Then, the process is completed.

The above operation enables replacement of data on the display portion by an action similar to flipping a page of a book. Thus, the operation of turning a page can be easily performed by an intuitive action. The above operation can particularly improve operability of an e-book reader, which is an example of a data processing device.

Note that this embodiment can be combined with any of the other embodiments in this specification as appropriate.

### Embodiment 2

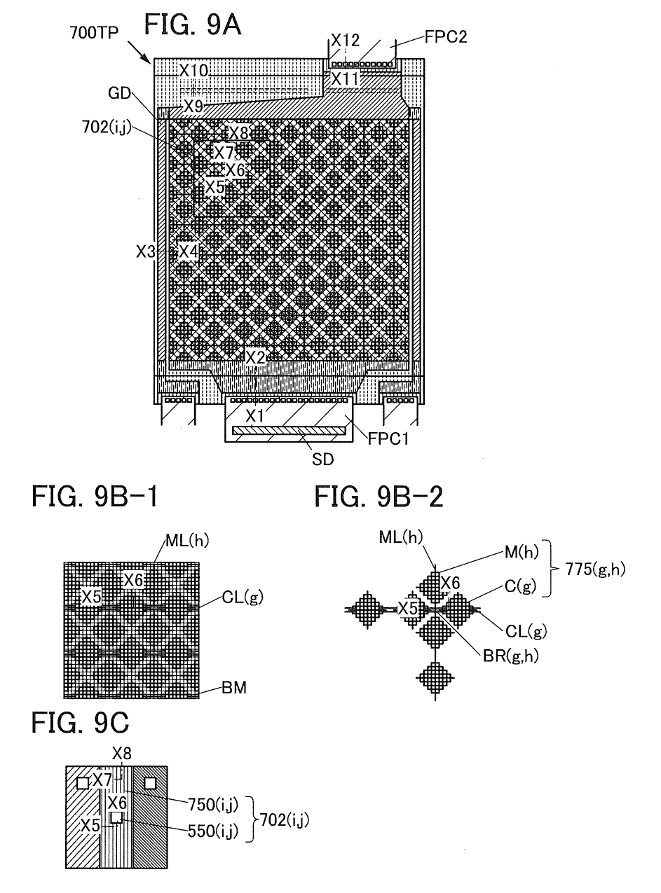

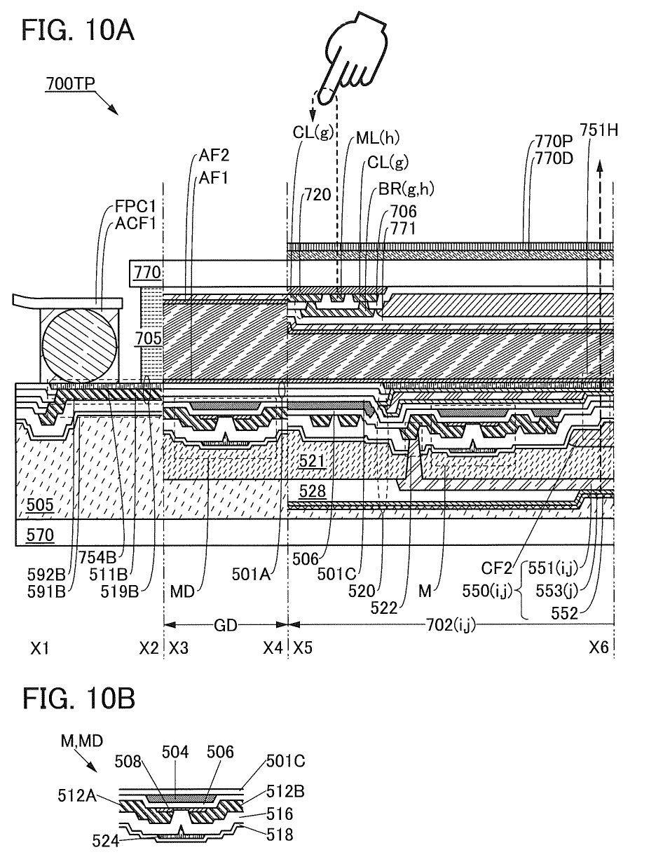

In this embodiment, the structure of an input/output device of one embodiment of the present invention will be described with reference to FIG. 8, FIGS. 9A, 9B1, 9B2, and 9C, FIGS. 10A and 10B, FIGS. 11A and 11B, FIGS. 12A and 12B, FIG. 13, and FIGS. 14A to 14C.

FIG. 8 is a block diagram illustrating the structure of the input/output device one embodiment of the present invention.

FIGS. 9A to 9C illustrate the structure of the input/output panel 700TP that can be used in the input/output device of one embodiment of the present invention. FIG. 9A is a top view of the input/output panel 700TP. FIG. 9B1 is a schematic view illustrating part of the input portion of the input/output panel 700TP. FIG. 9B2 is a schematic view illustrating part of the structure in FIG. 9B 1. FIG. 9C is a schematic view illustrating the structure of a pixel 702 (i,j) which can be used in the input/output panel 700TP.

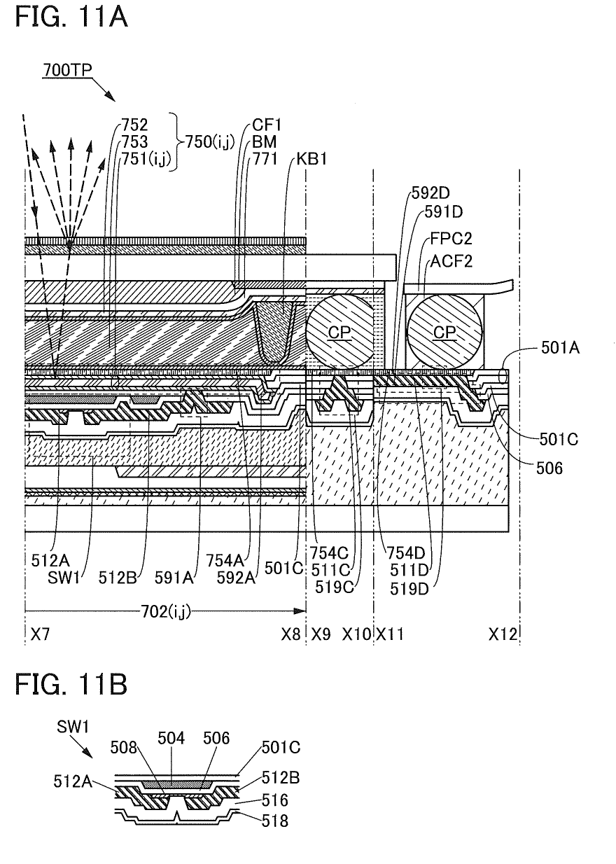

FIGS. 10A and 10B and FIGS. 11A and 11B are cross-sectional view illustrating the structure of the input/output panel 700TP. FIG. 10A is a cross-sectional view taken along the lines X1-X2, X3-X4, and X5-X6 in FIG. 9A. FIG. 10B illustrates part of the structure in FIG. 10A.

FIG. 11A is a cross-sectional view taken along the lines X7-X8, X9-X10, and X11-X12 in FIG. 9A. FIG. 11B illustrates part of the structure in FIG. 11A.

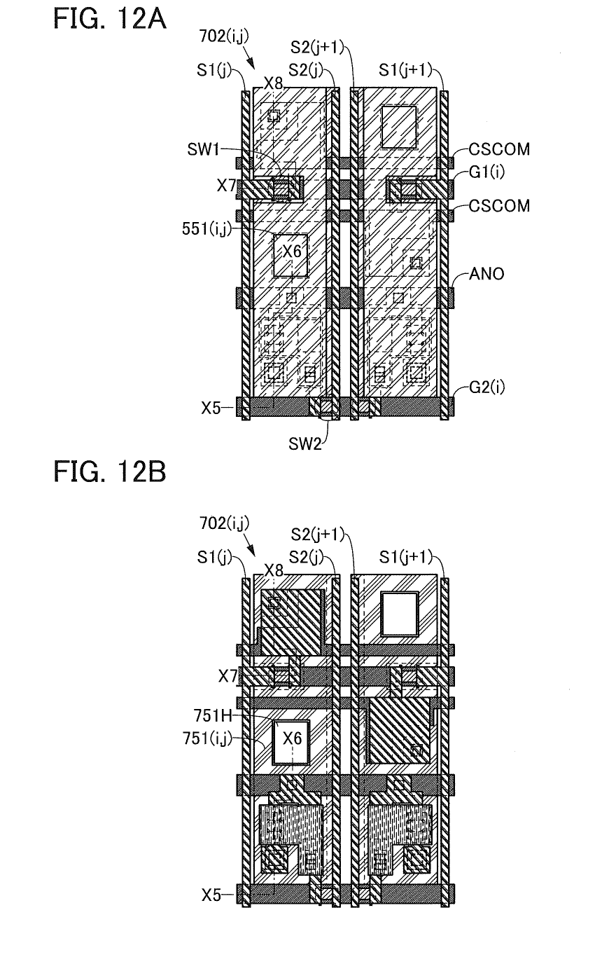

FIG. 12A is a bottom view illustrating part of a pixel in the input/output panel 700TP in FIG. 9C. FIG. 12B is a bottom view illustrating the structure in FIG. 12A, in which some components are omitted.

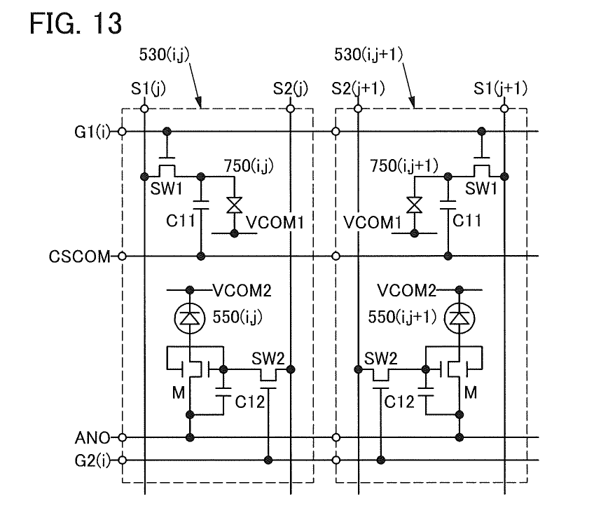

FIG. 13 is a circuit diagram illustrating the configuration of a pixel circuit included in the input/output panel 700TP of one embodiment of the present invention.

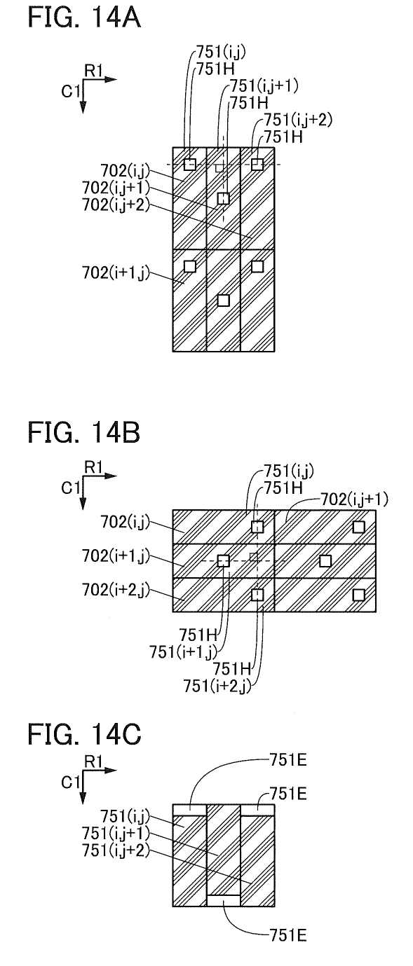

FIGS. 14A to 14C are schematic views illustrating the shape of a reflective film that can be used for a pixel in the input/output panel 700TP.

Note that in this specification, an integral variable of 1 or more may be used for reference numerals. For example, “(p)” where p is an integral variable of 1 or more may be used for part of a reference numeral that specifies any one of components (p components at a maximum). For another example, “(m,n)” where m and n are each an integral variable of 1 or more may be used for part of a reference numeral that specifies any one of components (m×n components at a maximum).

### Structure Example of Input/Output Panel 700TP

The input/output panel 700TP described in this embodiment includes a display region 231 (see FIG. 8). The input/output panel 700TP can also include the driver circuit GD or the driver circuit SD.

### <<Display Region 231>>

The display region 231 includes one group of pixels 702(i,1) to 702(i,n), another group of pixels 702(1,j) to 702(m,j), and a scan line G1(i) (see FIG. 8, FIGS. 12A and 12B, or FIG. 13). The display region 231 also includes a scan line G2(i), a wiring CSCOM, a third conductive film ANO, and a signal line S2(j). Note that i is an integer greater than or equal to 1 and less than or equal to m,j is an integer greater than or equal to 1 and less than or equal to n, and each of m and n is an integer greater than or equal to 1.

The one group of pixels 702(i,1) to 702(i,n) include the pixel 702(i,j) and are provided in the row direction (the direction indicated by the arrow R1 in the drawing).

The another group of pixels 702(1,j) to 702(m,j) include the pixel 702(i,j) and are provided in the column direction (the direction indicated by the arrow C1 in the drawing) that intersects the row direction.

The scan line G1(i) and the scan line G2(i) are electrically connected to the one group of pixels 702(i,1) to 702(i,n) provided in the row direction.

The another group of pixels 702(1,j) to 702(m,j) provided in the column direction are electrically connected to a signal line S1(j) and the signal line S2(j).

### <<Driver Circuit GD>>

The driver circuit GD has a function of supplying a selection signal in accordance with the control data.

For example, the driver circuit GD has a function of supplying a selection signal to one scan line at a frequency of 30 Hz or higher, preferably 60 Hz or higher, in accordance with the control data. Accordingly, moving images can be smoothly displayed.

For example, the driver circuit GD has a function of supplying a selection signal to one scan line at a frequency of lower than 30 Hz, preferably lower than 1 Hz, further preferably less than once per minute, in accordance with the control data. Accordingly, a still image can be displayed while flickering is suppressed.

In the case where a plurality of driver circuits is provided, for example, the driver circuits GDA and GDB may supply the selection signals at different frequencies. Specifically, the driver circuits can supply selection signals at a higher frequency to a region where moving images are displayed smoothly than to a region where a still image is displayed while flickering is suppressed.

### <<Driver Circuit SD, Driver Circuit SD1, and Driver Circuit SD2>>

The driver circuit SD includes a driver circuit SD1 and a driver circuit SD2. The driver circuit SD1 has a function of supplying an image signal on the basis of the data V1. The driver circuit SD2 has a function of supplying an image signal on the basis of the data V2 (see FIG. 8). Note that the data V1 correspond to data displayed by a first display element and the data V2 correspond to data displayed by a second display element.

The driver circuit SD1 has a function of generating an image signal that is supplied to a pixel circuit electrically connected to one display element. Specifically, the driver circuit SD1 has a function of generating a signal whose polarity is inverted. Thus, for example, a liquid crystal display element can be driven.

The driver circuit SD2 has a function of generating an image signal that is supplied to a pixel circuit electrically connected to another display element which displays an image by a method different from that of the above display element. For example, an organic electroluminescence (EL) element can be driven.

A variety of sequential circuits, such as a shift register, can be used as the driver circuit SD, for example.

An integrated circuit in which the driver circuit SD1 and the driver circuit SD2 are integrated, for example, can be used for the driver circuit SD. Specifically, an integrated circuit formed on a silicon substrate can be used as the driver circuit SD.

An integrated circuit can be mounted on a terminal by a chip on glass (COG) method or a chip on film (COF) method, for example. Specifically, an anisotropic conductive film can be used to mount an integrated circuit on the terminal.

### Structure Example of Pixel

In the input/output panel 700TP, the pixel 702(i,j) includes the first display element 750(i,j), the second display element 550(i,j), and part of a functional layer 520 (see FIG. 9C, FIG. 10A, and FIG. 11A).

### <<Functional Layer>>

The functional layer 520 includes a first conductive film, a second conductive film, an insulating film 501C, and a pixel circuit 530(i,j) (see FIG. 10A and FIG. 13). The functional layer 520 includes an insulating film 521, an insulating film 528, an insulating film 518, and an insulating film 516.

The functional layer 520 includes a region sandwiched between a substrate 570 and a substrate 770.

### <<Insulating Film 501C>>

The insulating film 501C includes a region sandwiched between the first conductive film and the second conductive film, and also has an opening 591A (see FIG. 11A). The opening 591A is also formed in an insulating film 506 (see FIG. 10A).

### <<First Conductive Film>>

For example, a first electrode 751(i,j) of the first display element 750(i,j) can be used as the first conductive film. The first conductive film is electrically connected to the first electrode 751(i,j).

### <<Second Conductive Film>>

For example, a conductive film 512B can be used as the second conductive film. The second conductive film has a region overlapping with the first conductive film. The second conductive film is electrically connected to the first conductive film through the opening 591A. The first conductive film electrically connected to the second conductive film through the opening 591A provided in the insulating films 501C and 506 can be referred to as a through electrode.

The second conductive film is electrically connected to the pixel circuit 530(i,j). For example, a conductive film which functions as a source electrode or a drain electrode of a transistor used as a switch SW1 of the pixel circuit 530(i,j) can be used as the second conductive film.

### <<Pixel Circuit>>

The pixel circuit 530(i,j) has a function of driving the first display element 750(i,j) and the second display element 550(i,j) (see FIG. 13).

A switch, a transistor, a diode, a resistor, an inductor, a capacitor, or the like can be used in the pixel circuit 530(i,j).

For example, one or a plurality of transistors can be used as a switch. A plurality of transistors connected in parallel, in series, or in combination of parallel connection and series connection can be used as a switch.

The pixel circuit 530(i,j) is electrically connected to the signal line S1(j), the signal line S2(j), the scan line G1(i), the scan line G2(i), the wiring CSCOM, and the third conductive film ANO, for example (see FIG. 13). Note that a conductive film 512A is electrically connected to the signal line S1(j) (see FIG. 11A and FIG. 13).

The pixel circuit 530(i,j) includes the switch SW1 and a capacitor C11 (see FIG. 13).

The pixel circuit 530(i,j) includes a switch SW2, a transistor M, and a capacitor C12. For example, a transistor including a gate electrode electrically connected to the scan line G1(i) and a first electrode electrically connected to the signal line S1(j) can be used as the switch SW1.

The capacitor C11 includes a first electrode electrically connected to a second electrode of the transistor used as the switch SW1 and a second electrode electrically connected to the wiring CSCOM.

For example, a transistor that includes a gate electrode electrically connected to the scan line G2(i) and a first electrode electrically connected to the signal line S2(j) can be used as the switch SW2.

The transistor M includes a gate electrode electrically connected to the second electrode of the transistor used as the switch SW2 and a first electrode electrically connected to the third conductive film ANO.

Note that a transistor that includes a semiconductor film provided between a gate electrode and a conductive film can be used as the transistor M. For example, as the conductive film, a conductive film electrically connected to a wiring that can supply the same potential as that of the gate electrode of the transistor M can be used.

The capacitor C12 includes a first electrode electrically connected to a second electrode of the transistor used as the switch SW2 and a second electrode electrically connected to the first electrode of the transistor M.

Note that a first electrode of the first display element 750(i,j) is electrically connected to the second electrode of the transistor used as the switch SW1. A second electrode of the first display element 750(i,j) is electrically connected to a wiring VCOM1. This enables the first display element 750 to be driven.

Furthermore, a third electrode 551(i,j) and a fourth electrode 552 of the second display element 550(i,j) are electrically connected to the second electrode of the transistor M and a fourth conductive film VCOM2, respectively. This enables the second display element 550(i,j) to be driven.

<<First Display Element 750(i,j)>>

A display element having a function of controlling transmission or reflection of light, for example, can be used as the first display element 750(i,j). Specifically, a reflective liquid crystal display element can be used as the first display element 750(i,j). Alternatively, a MEMS shutter display element or the like can be used. The use of a reflective display element can reduce the power consumption of the input/output panel 700TP.

The first display element 750(i,j) includes the first electrode 751(i,j), a second electrode 752, and a layer 753 containing a liquid crystal material. The second electrode 752 is positioned such that an electric field which controls the alignment of the liquid crystal material is generated between the second electrode 752 and the first electrode 751(i,j) (see FIG. 11A).

Note that the first display element 750(i,j) includes an alignment film AF1 and an alignment film AF2. The alignment film AF2 has such a region that the layer 753 containing a liquid crystal material is interposed between the alignment film AF1 and the region of the alignment film AF2 (see FIG. 10A).

<<Second Display Element 550(i,j)>>

A display element having a function of emitting light, for example, can be used as the second display element 550(i,j). Specifically, an organic EL element or the like can be used.

The second display element 550(i,j) has a function of emitting light toward the insulating film 501C (see FIG. 10A).

The second display element 550(i,j) is provided so that the display using the second display element 550(i,j) can be seen from part of a region from which the display using the first display element 750(i,j) can be seen. Dashed arrows shown in FIG. 11A denote the directions in which external light is incident on and reflected by the first display element 750(i,j) that displays the data with control of the intensity of external light reflection, for example. A dashed arrow shown in FIG. 10A denotes the direction in which the second display element 550(i,j) emits light to the part of the region from which the display using the first display element 750(i,j) can be seen.

Thus, the display using the second display element can be seen from part of the region from which the display using the first display element can be seen. A user can view the display without changing the attitude or the like of the input/output panel 700TP. The visibility and operational reliability of the input/output panel 700TP can be improved.

The second display element 550(i,j) includes the third electrode 551(i,j), the fourth electrode 552, and a layer 553(j) containing a light-emitting material (see FIG. 10A).

The fourth electrode 552 includes a region overlapping with the third electrode 551(i,j).

The layer 553(j) containing a light-emitting material includes a region sandwiched between the third electrode 551(i,j) and the fourth electrode 552.

The third electrode 551(i,j) is electrically connected to the pixel circuit 530(i,j) at a connection portion 522. Note that the third electrode 551(i,j) and the fourth electrode 552 are electrically connected to the third conductive film ANO and the fourth conductive film VCOM2, respectively (see FIG. 13).

### <<Intermediate Film>>

The input/output panel 700TP described in this embodiment includes an intermediate film 754A, an intermediate film 754B, an intermediate film 754C, and an intermediate film 754D.

The intermediate film 754A includes a region which overlaps with the insulating film 501C with the first conductive film interposed therebetween, and the intermediate film 754A includes a region in contact with first electrode 751(i,j). The intermediate film 754B includes a region in contact with a conductive film 511B. The intermediate film 754C includes a region in contact with a conductive film 511C. The intermediate film 754D includes a region in contact with a conductive film 511D.

### <<Insulating Film 501A>>

The input/output panel 700TP described in this embodiment includes an insulating film 501A (see FIG. 10A).

The insulating film 501A has a first opening 592A, a second opening 592B, and an opening 592D (see FIG. 10A or FIG. 11A).

The first opening 592A includes a region overlapping with the intermediate film 754A and the first electrode 751(i,j) or a region overlapping with the intermediate film 754A and the insulating film 501C.

The second opening 592B includes a region overlapping with the intermediate film 754B and the conductive film 511B.

The opening 592D includes a region overlapping with the intermediate film 754D and the conductive film 511D.

Although a reference numeral is not given, the insulating film 501A has an opening that overlaps with the intermediate film 754C and the conductive film 511C in a region X9-X10 in FIG. 11A.

The insulating film 501A includes a region where the insulating films 501C and 506 are sandwiched between the insulating film 501A and the conductive film 511B. The insulating film 501A is in contact with the conductive film 511B in an opening 591B provided in the insulating films 501C and 506. The insulating film 501A is in contact with the conductive film 511D in an opening 591D provided in the insulating films 501C and 506.

### <<Insulating Film 521, Insulating Film 528, Insulating Film 518, Insulating Film 516, or the Like>>

The insulating film 521 includes a region sandwiched between the pixel circuit 530(i,j) and the second display element 550(i,j).

The insulating film 528 is provided between the insulating film 521 and the substrate 570 and has an opening in a region overlapping with the second display element 550(i,j).

The insulating film 528 formed along the periphery of the third electrode 551(i,j) can prevent a short circuit between the third electrode 551(i,j) and the fourth electrode.

The insulating film 518 (see FIG. 10B and FIG. 11B) includes a region sandwiched between the insulating film 521 and the pixel circuit 530(i,j).

The insulating film 516 (see FIG. 10B and FIG. 11B) includes a region sandwiched between the insulating film 518 and the pixel circuit 530(i,j).

### <<Terminal or the Like>>

The input/output panel 700TP described in this embodiment includes a terminal 519B, a terminal 519C, and a terminal 519D.

The terminal 519B includes the conductive film 511B and the intermediate film 754B, and the intermediate film 754B includes a region in contact with the conductive film 511B. The terminal 519B is electrically connected to the signal line S1(j), for example.

The terminal 519C includes the conductive film 511C and the intermediate film 754C, and the intermediate film 754C includes a region in contact with the conductive film 511C. The conductive film 511C is electrically connected to the wiring VCOM1, for example.

A conductive material CP is sandwiched between the terminal 519C and the second electrode 752, and has a function of electrically connecting the terminal 519C and the second electrode 752. For example, a conductive particle can be used as the conductive material CP.

The terminal 519D is provided with the conductive film 511D and the intermediate film 754D, and the intermediate film 754D includes a region in contact with the conductive film 511D.

### <<Substrate or the Like>>

The input/output panel 700TP described in this embodiment includes the substrate 570 and the substrate 770.

The substrate 770 includes a region overlapping with the substrate 570. The substrate 770 includes a region where the functional layer 520 is interposed between the substrate 770 and the substrate 570.

### <<Bonding Layer, Sealant, Structure Body, or the Like>>

The input/output panel 700TP described in this embodiment also includes a bonding layer 505, a sealant 705, and a structure body KB1.

The bonding layer 505 includes a region sandwiched between the functional layer 520 and the substrate 570, and has a function of bonding the functional layer 520 and the substrate 570 together.

The sealant 705 includes a region sandwiched between the functional layer 520 and the substrate 770, and has a function of bonding the functional layer 520 and the substrate 770 together.

The structure body KB1 has a function of providing a certain space between the functional layer 520 and the substrate 770.

### <<Functional Film or the Like>>

The input/output panel 700TP described in this embodiment includes a light-blocking film BM, an insulating film 771, a functional film 770P, and a functional film 770D. In addition, a coloring film CF1 and a coloring film CF2 are included.

The light-blocking film BM has an opening in a region overlapping with the first display element 750(i,j). The coloring film CF2 is provided between the insulating film 501C and the second display element 550(i,j) and includes a region overlapping with an opening 751H (see FIG. 10A).

The insulating film 771 includes a region sandwiched between the coloring film CF1 and the layer 753 containing a liquid crystal material or between the light-blocking film BM and the layer 753 containing a liquid crystal material. Thus, unevenness due to the thickness of the coloring film CF1 can be avoided. Impurities can be prevented from being diffused from the light-blocking film BM, the coloring film CF1, or the like into the layer 753 containing a liquid crystal material

The functional film 770P includes a region overlapping with the first display element 750(i,j).

The functional film 770D includes a region overlapping with the first display element 750(i,j). The functional film 770D is provided so that the substrate 770 lies between the functional film 770D and the first display element 750(i,j). This can diffuse light reflected by the first display element 750(i,j), for example.

### <<Substrate 570>>

The substrate 570 or the like can be formed using a material having heat resistance high enough to withstand heat treatment in the manufacturing process. For example, a material with a thickness less than or equal to 0.7 mm and greater than or equal to 0.1 mm can be used as the substrate 570. Specifically, a material polished to a thickness of approximately 0.1 mm can be used.

For example, a large-sized glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramic, or metal can be used for the substrate 570 or the like.

Specifically, non-alkali glass, soda-lime glass, potash glass, crystal glass, aluminosilicate glass, tempered glass, chemically tempered glass, quartz, sapphire, or the like can be used for the substrate 570 or the like. Specifically, an inorganic oxide film, an inorganic nitride film, an inorganic oxynitride film, or the like can be used for the substrate 570 or the like. For example, a silicon oxide film, a silicon nitride film, a silicon oxynitride film, an aluminum oxide film, or the like can be used for the substrate 570 or the like. Stainless steel, aluminum, or the like can be used for the substrate 570 or the like.

For example, a single crystal semiconductor substrate or a polycrystalline semiconductor substrate of silicon or silicon carbide, a compound semiconductor substrate of silicon germanium or the like, an SOI substrate, or the like can be used as the substrate 570 or the like. Thus, a semiconductor element can be provided over the substrate 570 or the like.

For example, an organic material such as a resin, a resin film, or plastic can be used for the substrate 570 or the like. Specifically, a resin film or a resin plate of polyester, polyolefin, polyamide, polyimide, polycarbonate, an acrylic resin, or the like can be used for the substrate 570 or the like.

For example, a composite material formed by attaching a metal plate, a thin glass plate, or a film of an inorganic material to a resin film or the like can be used for the substrate 570 or the like. For example, a composite material formed by dispersing a fibrous or particulate metal, glass, an inorganic material, or the like into a resin film can be used for the substrate 570 or the like. For example, a composite material formed by dispersing a fibrous or particulate resin, an organic material, or the like into an inorganic material can be used for the substrate 570 or the like.

Furthermore, a single-layer material or a layered material in which a plurality of layers are stacked can be used for the substrate 570 or the like. For example, a layered material in which a base, an insulating film that prevents diffusion of impurities contained in the base, and the like are stacked can be used for the substrate 570 or the like. Specifically, a layered material in which glass and one or a plurality of films that are selected from a silicon oxide layer, a silicon nitride layer, a silicon oxynitride layer, and the like and that prevent diffusion of impurities contained in the glass are stacked can be used for the substrate 570 or the like. Alternatively, a layered material in which a resin and a film for preventing diffusion of impurities that penetrate the resin, such as a silicon oxide film, a silicon nitride film, or a silicon oxynitride film, are stacked can be used for the substrate 570 or the like.

Specifically, a resin film, a resin plate, a layered material, or the like of polyester, polyolefin, polyamide, polyimide, polycarbonate, an acrylic resin, or the like can be used for the substrate 570 or the like.

Specifically, a material including polyester, polyolefin, polyamide (e.g., nylon or aramid), polyimide, polycarbonate, polyurethane, an acrylic resin, an epoxy resin, or a resin having a siloxane bond, such as silicone, can be used for the substrate 570 or the like.

Specifically, polyethylene terephthalate (PET), polyethylene naphthalate (PEN), polyethersulfone (PES), an acrylic resin, or the like can be used for the substrate 570 or the like. Alternatively, a cyclo olefin polymer (COP), a cyclo olefin copolymer (COC), or the like can be used.

Alternatively, paper, wood, or the like can be used for the substrate 570 or the like.

For example, a flexible substrate can be used as the substrate 570 or the like.

Note that a transistor, a capacitor, or the like can be directly formed on the substrate. Alternatively, a transistor, a capacitor, or the like can be formed on a substrate which is for use in the manufacturing process and can withstand heat applied in the manufacturing process, and then the transistor, the capacitor, or the like can be transferred to the substrate 570 or the like. Accordingly, a transistor, a capacitor, or the like can be formed over a flexible substrate.

### <<Substrate 770>>

For example, a light-transmitting material can be used for the substrate 770. Specifically, any of the materials that can be used for the substrate 570 can be used for the substrate 770.

For example, aluminosilicate glass, tempered glass, chemically tempered glass, sapphire, or the like can be suitably used for the substrate 770 that is provided on the user side of the input/output device. This can prevent damage or a crack of the input/output device caused by the use thereof.

Moreover, a material having a thickness greater than or equal to 0.1 mm and less than or equal to 0.7 mm, for example, can be used for the substrate 770. Specifically, a substrate polished for reducing the thickness can be used. Thus, the functional film 770D can be located close to the first display element 750(i,j). As a result, image blur can be reduced and an image can be displayed clearly.

### <<Structure Body KB1>>

An organic material, an inorganic material, or a composite material of an organic material and an inorganic material, for example, can be used for the structure body KB1 or the like. Accordingly, a predetermined space can be provided between components between which the structure KB1 and the like are provided.

Specifically, for the structure body KB1, polyester, polyolefin, polyamide, polyimide, polycarbonate, polysiloxane, an acrylic resin, or the like, or a composite material of a plurality of resins selected from these can be used. Alternatively, a photosensitive material may be used.

### <<Sealant 705>>

For the sealant 705 or the like, an inorganic material, an organic material, a composite material of an inorganic material and an organic material, or the like can be used.

For example, an organic material such as a thermally fusible resin or a curable resin can be used for the sealant 705 or the like.

For example, an organic material such as a reactive curable adhesive, a light curable adhesive, a thermosetting adhesive, and/or an anaerobic adhesive can be used for the sealant 705 or the like.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, or the like can be used for the sealant 705 or the like.

### <<Bonding Layer 505>>

For example, any of the materials that can be used for the sealant 705 can be used for the bonding layer 505.

### <<Insulating Film 521>>

An insulating inorganic material, an insulating organic material, or an insulating composite material containing an inorganic material and an organic material, for example, can be used for the insulating film 521 or the like.

Specifically, an inorganic oxide film, an inorganic nitride film, an inorganic oxynitride film, or a layered material obtained by stacking some of these films can be used as the insulating film 521 or the like. For example, a film including any of a silicon oxide film, a silicon nitride film, a silicon oxynitride film, an aluminum oxide film, and the like, or a film including a material obtained by stacking some of these films can be used as the insulating film 521 or the like.

Specifically, for the insulating film 521 or the like, polyester, polyolefin, polyamide, polyimide, polycarbonate, polysiloxane, an acrylic resin, or the like, or a layered or composite material of a plurality of kinds of resins selected from these can be used. Alternatively, a photosensitive material may be used.

Thus, steps due to various components overlapping with the insulating film 521, for example, can be reduced.

### <<Insulating Film 528>>

Any of the materials that can be used for the insulating film 521, for example, can be used for the insulating film 528 or the like. Specifically, a 1-μm-thick polyimide-containing film can be used as the insulating film 528.

### <<Insulating Film 501A>>

Any of the materials that can be used for the insulating film 521, for example, can be used for the insulating film 501A. A material having a function of supplying hydrogen, for example, can be used for the insulating film 501A.

Specifically, a material obtained by stacking a material containing silicon and oxygen and a material containing silicon and nitrogen can be used for the insulating film 501A. For example, a material having a function of releasing hydrogen by heating or the like to supply the hydrogen to another component can be used for the insulating film 501A. Specifically, a material having a function of releasing hydrogen taken in the manufacturing process, by heating or the like, to supply the hydrogen to another component can be used for the insulating film 501A.

For example, a film containing silicon and oxygen that is formed by a chemical vapor deposition method using silane or the like as a source gas can be used as the insulating film 501A.

Specifically, a material obtained by stacking a material containing silicon and oxygen and having a thickness greater than or equal to 200 nm and less than or equal to 600 nm and a material containing silicon and nitrogen and having a thickness of approximately 200 nm can be used for the insulating film 501A.

### <<Insulating Film 501C>>

Any of the materials that can be used for the insulating film 521, for example, can be used for the insulating film 501C. Specifically, a material containing silicon and oxygen can be used for the insulating film 501C. Thus, impurity diffusion into the pixel circuit or the second display element can be suppressed.

For example, a 200-nm-thick film containing silicon, oxygen, and nitrogen can be used as the insulating film 501C.

### <<Intermediate Film 754A, Intermediate Film 754B, Intermediate Film 754C, and Intermediate Film 754D>>

For example, a film with a thickness greater than or equal to 10 nm and less than or equal to 500 nm, preferably greater than or equal to 10 nm and less than or equal to 100 nm can be used as the intermediate film 754A, the intermediate film 754B, the intermediate film 754C, or the intermediate film 754D. In this specification, the intermediate film 754A, the intermediate film 754B, the intermediate film 754C, or the intermediate film 754D is referred to as an intermediate film.

For example, a material having a function of allowing the passage of hydrogen or the supply of hydrogen can be used for the intermediate film.

For example, a conductive material can be used for the intermediate film.

For example, a light-transmitting material can be used for the intermediate film.

Specifically, a material containing indium and oxygen, a material containing indium, gallium, zinc, and oxygen, a material containing indium, tin, and oxygen, or the like can be used for the intermediate film. Note that these materials have a function of allowing the passage of hydrogen.

Specifically, a 50- or 100-nm-thick film containing indium, gallium, zinc, and oxygen can be used as the intermediate film.

Note that a material obtained by stacking films serving as an etching stopper can be used as the intermediate film. Specifically, a layered material obtained by stacking a 50-nm-thick film containing indium, gallium, zinc, and oxygen and a 20-nm-thick film containing indium, tin, and oxygen, in this order, can be used for the intermediate film.

### <<Wiring, Terminal, Conductive Film>>

A conductive material can be used for a wiring or the like. Specifically, the conductive material can be used for the signal line S1(j), the signal line S2(j), the scan line G1(i), the scan line G2(i), the wiring CSCOM, the third conductive film ANO, the terminal 519B, the terminal 519C, the terminal 719, the conductive film 511B, the conductive film 511C, or the like.

For example, an inorganic conductive material, an organic conductive material, a metal material, a conductive ceramic material, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese, or the like can be used for the wiring or the like. Alternatively, an alloy including any of the above-described metal elements, or the like can be used for the wiring or the like. In particular, an alloy of copper and manganese is suitably used in microfabrication with use of a wet etching method.

Specifically, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, or the like can be used for the wiring or the like.

Specifically, a conductive oxide such as indium oxide, indium tin oxide, indium zinc oxide, zinc oxide, or zinc oxide to which gallium is added can be used for the wiring or the like.

Specifically, a film containing graphene or graphite can be used for the wiring or the like.

For example, a film including graphene oxide is formed and is reduced, so that a film including graphene can be formed. As a reducing method, a method using heat, a method using a reducing agent, or the like can be employed.

For example, a film including a metal nanowire can be used for the wiring or the like. Specifically, a nanowire including silver can be used.

Specifically, a conductive high molecule can be used for the wiring or the like.

Note that the terminal 519B can be electrically connected to a flexible printed circuit FPC1 using a conductive material ACF1, for example.

### <<First Conductive Film, Second Conductive Film>>

For example, the material that can be used for the wiring or the like can be used for the first conductive film or the second conductive film.

The first electrode 751(i,j), the wiring, or the like can be used for the first conductive film.

The conductive film 512B serving as a source electrode or a drain electrode of a transistor that can be used as the switch SW1, or the wiring or the like can be used for the second conductive film.

<<First Display Element 750(i,j)>>

A display element having a function of controlling transmission or reflection of light, for example, can be used as the first display element 750(i,j). For example, a combined structure of a liquid crystal element and a polarizing plate or a MEMS shutter display element can be used. Specifically, a reflective liquid crystal display element can be used as the first display element 750(i,j). The use of a reflective display element can reduce the power consumption of an input/output device.

For example, a liquid crystal element that can be driven by any of the following driving methods can be used: an in-plane switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

In addition, a liquid crystal element that can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode can be used.

The first display element 750(i,j) includes the first electrode, the second electrode, and a layer containing a liquid crystal material. The layer containing a liquid crystal material contains a liquid crystal material whose alignment is controlled by a voltage applied between the first electrode and the second electrode. For example, the alignment of the liquid crystal material can be controlled by an electric field in the thickness direction (also referred to as the vertical direction), the direction that crosses the vertical direction (the horizontal direction, or the diagonal direction) of the layer containing a liquid crystal material.

### <<Layer 753 Containing Liquid Crystal Material>>

Thermotropic liquid crystal, low-molecular liquid crystal, high-molecular liquid crystal, polymer dispersed liquid crystal, ferroelectric liquid crystal, anti-ferroelectric liquid crystal, or the like, for example, can be used for the layer containing a liquid crystal material. A liquid crystal material that exhibits a cholesteric phase, a smectic phase, a cubic phase, a chiral nematic phase, an isotropic phase, or the like can be used. Alternatively, a liquid crystal material that exhibits a blue phase can be used.

<<First Electrode 751(i,j)>>

For example, the material that is used for the wiring or the like can be used for the first electrode 751(i,j). Specifically, a reflective film can be used for the first electrode 751(i,j). For example, a material in which a light-transmitting conductive film and a reflective film having an opening are stacked can be used for the first electrode 751(i,j).

### <<Reflective Film>>

A material reflecting visible light can be used for the reflective film, for example. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750 to serve as a reflective liquid crystal element. A material with an uneven surface can be used for the reflective film, for example. In that case, incident light can be reflected in various directions so that a white image can be displayed.

For example, the first conductive film, the first electrode 751(i,j), or the like can be used as a reflective film.

For example, a film including a region sandwiched between the layer 753 containing a liquid crystal material and the first electrode 751(i,j) can be used as the reflective film. Alternatively, as the reflective film, a film including a region positioned such that the first electrode 751(i,j) having a light-transmitting property is sandwiched between the region and the layer 753 containing a liquid crystal material can be used.

The reflective film has a shape, for example, including a region that does not block light emitted from the second display element 550(i,j).

For example, the reflective film may have a shape with one or a plurality of openings.

The opening may have a polygonal shape, a quadrangular shape, an elliptical shape, a circular shape, a cross-like shape, or the like. The opening 751H may also have a stripe shape, a slit-like shape, or a checkered pattern.

If the ratio of the total area of the opening 751H to the total area excluding the openings is too high, display performed using the first display element 750(i,j) is dark.

If the ratio of the total area of the opening 751H to the total area excluding the openings is too low, display performed using the second display element 550(i,j) is dark. Alternatively, the reliability of the second display element 550(i,j) is reduced in some cases.

The opening 751H of the pixel 702(i,j+1), which is adjacent to the pixel 702(i,j), is not provided on a line that extends in the row direction (the direction indicated by the arrow R1 in each of FIGS. 14A to 14C) through the opening 751H of the pixel 702(i,j) (see FIG. 14A). Alternatively, for example, the opening 751H of the pixel 702(i+1,j), which is adjacent to the pixel 702(i,j), is not provided on a line that extends in the column direction (the direction indicated by the arrow C1 in each of FIGS. 14A to 14C) through the opening 751H of the pixel 702(i,j) (see FIG. 14B).

For example, the opening 751H of the pixel 702(i,j+2) is provided on a line that extends in the row direction through the opening 751H of the pixel 702(i,j) (see FIG. 14A). In addition, the opening 751H of the pixel 702(i,j+1) is provided on a line that is perpendicular to the above-mentioned line between the opening 751H of the pixel 702(i,j) and the opening 751H of the pixel 702(i,j+2).

Alternatively, for example, the opening 751H of the pixel 702(i+2,j) is provided on a line that extends in the column direction through the opening 751H of the pixel 702(i,j) (see FIG. 14B). In addition, for example, the opening 751H of the pixel 702(i+1,j) is provided on a line that is perpendicular to the above-mentioned line between the opening 751H of the pixel 702(i,j) and the opening 751H of the pixel 702(i+2,j).

Thus, a second display element that includes a region overlapping with an opening of a pixel adjacent to one pixel can be apart from a second display element that includes a region overlapping with an opening of the one pixel. Furthermore, a display element that exhibits color different from that exhibited by the second display element of the one pixel can be provided as the second display element of the pixel adjacent to the one pixel. Furthermore, the difficulty in adjacently arranging a plurality of display elements that exhibit different colors can be lowered. As a result, the visibility and operational reliability of the input/output panel 700TP can be improved.

For example, the reflective film can be formed using a material having a shape in which an end portion is cut off so as to form a region 751E that does not block light emitted from the second display element 550(i,j) (see FIG. 14C). Specifically, the first electrode 751(i,j) whose end portion is cut off so as to be shorter in the column direction (the direction indicated by the arrow C1 in the drawing) can be used as the reflective film.

### <<Second Electrode 752>>

A material having conductivity can be used for the second electrode 752, for example. A material having a visible-light-transmitting property can be used for the second electrode 752.

For example, a conductive oxide, a metal film thin enough to transmit light, or a metal nanowire can be used for the second electrode 752.

Specifically, a conductive oxide containing indium can be used for the second electrode 752. Alternatively, a metal thin film with a thickness greater than or equal to 1 nm and less than or equal to 10 nm can be used for the second electrode 752. Alternatively, a metal nanowire containing silver can be used for the second electrode 752.

Specifically, indium oxide, indium tin oxide, indium zinc oxide, zinc oxide, zinc oxide to which gallium is added, zinc oxide to which aluminum is added, or the like can be used for the second electrode 752.

### <<Alignment Film AF1 and Alignment Film AF2>>

A material containing polyimide or the like can be can be used as the alignment film AF1 or the alignment film AF2. Specifically, a material formed by rubbing treatment or an optical alignment technique so that a liquid crystal material has alignment in a predetermined direction can be used.

For example, a film containing soluble polyimide can be used as the alignment film AF1 or the alignment film AF2. In this case, the temperature required in forming the alignment film AF1 can be low. Accordingly, damage to other components at the time of forming the alignment film AF1 can be suppressed.

### <<Coloring Film CF1 and Coloring Film CF2>>

A material transmitting light of a predetermined color can be used for the coloring film CF1 or the coloring film CF2. Thus, the coloring film CF1 or the coloring film CF2 can be used as a color filter, for example. For example, a material that transmits blue light, green light, or red light can be used for the coloring film CF1 or the coloring film CF2. Furthermore, a material that transmits yellow light, white light, or the like can be used for the coloring film.

Note that a material having a function of converting the emitted light to a predetermined color light can be used for the coloring film CF2. Specifically, quantum dots can be used for the coloring film CF2. Thus, display with high color purity can be achieved.

### <<Light-Blocking Film BM>>

A material that prevents light transmission can be used for the light-blocking film BM. Thus, the light-blocking film BM can be used as, for example, a black matrix.

### <<Insulating Film 771>>

The insulating film 771 can be formed of polyimide, an epoxy resin, an acrylic resin, or the like, for example.

### <<Functional Film 770P and Functional Film 770D>>

An anti-reflection film, a polarizing film, a retardation film, a light diffusion film, a condensing film, or the like, for example, can be used as the functional film 770P or the functional film 770D.

Specifically, a film containing a dichromatic pigment can be used as the functional film 770P or the functional film 770D. A material having a pillar-shaped structure with an axis in a direction that intersects a surface of the substrate can also be used for the functional film 770P or the functional film 770D. This makes it easy to transmit light in a direction along the axis and to scatter light in the other directions.

Alternatively, an antistatic film preventing the attachment of a foreign substance, a water repellent film suppressing the attachment of stain, a hard coat film suppressing a scratch in use, or the like can be used as the functional film 770P.

Specifically, a circularly polarizing film can be used as the functional film 770P, and a light diffusion film can be used as the functional film 770D.

<<Second Display Element 550(i,j)>>

The second display element 550(i,j) can be a light-emitting element, for example. Specifically, an organic EL element, an inorganic EL element, a light-emitting diode, or the like can be used as the second display element 550(i,j).

A light-emitting organic compound can be used for the layer 553(j) containing a light-emitting material, for example.

Quantum dots can be used for the layer 553(j) containing a light-emitting material, for example. Accordingly, the half width becomes narrow, and light of a bright color can be emitted.

A layered material for emitting blue light, green light, or red light, or the like can be used for the layer 553(j) containing a light-emitting material, for example.

A belt-like layered material that extends in the column direction along the signal line S2(j) can be used for the layer 553(j) containing a light-emitting material, for example.

A layered material for emitting white light can be used for the layer 553(j) containing a light-emitting material, for example. Specifically, a layered material in which a layer containing a light-emitting material including a fluorescent material that emits blue light, and a layer containing materials that are other than a fluorescent material and that emit green light and red light or a layer containing a material that is other than a fluorescent material and that emits yellow light are stacked can be used for the layer 553(j) containing a light-emitting material.

A material that can be used for the wiring or the like, for example, can be used for the third electrode 551(i,j).

For example, a material that transmits visible light selected from materials that can be used for the wiring or the like can be used for the third electrode 551(i,j).

Specifically, conductive oxide, indium-containing conductive oxide, indium oxide, indium tin oxide, indium zinc oxide, zinc oxide, zinc oxide to which gallium is added, or the like can be used for the third electrode 551(i,j). Alternatively, a metal film that is thin enough to transmit light can be used as the third electrode 551(i,j). Further alternatively, a metal film that transmits part of light and reflects another part of light can be used as the third electrode 551(i,j). Thus, the second display element 550(i,j) can be provided with a microcavity structure. Consequently, light of a predetermined wavelength can be extracted more efficiently than light of the other wavelengths.

A material that can be used for the wiring or the like, for example, can be used for the fourth electrode 552. Specifically, a material that reflects visible light can be used for the fourth electrode 552.

### <<Driver Circuit GD>>

Any of a variety of sequential circuits, such as a shift register, can be used as the driver circuit GD. For example, a transistor MD, a capacitor, and the like can be used in the driver circuit GD. Specifically, a transistor including a semiconductor film that can be formed in the same process as the semiconductor film of the transistor M or the transistor that can be used as the switch SW1 can be used.

As the transistor MD, a transistor having a different structure from the transistor that can be used as the switch SW1 can be used, for example. Specifically, a transistor including a conductive film 524 can be used as the transistor MD (see FIG. 10B).

Note that the transistor MD can have the same structure as the transistor M.

### <<Transistor>>

Semiconductor films formed at the same step can be used for transistors in the driver circuit and the pixel circuit, for example.

For example, a bottom-gate transistor, a top-gate transistor, or the like can be used for transistors in a driver circuit or a pixel circuit.

A manufacturing line for a bottom-gate transistor including amorphous silicon as a semiconductor can be easily remodeled into a manufacturing line for a bottom-gate transistor including an oxide semiconductor as a semiconductor, for example. Furthermore, for example, a manufacturing line for a top-gate transistor including polysilicon as a semiconductor can be easily remodeled into a manufacturing line for a top-gate transistor including an oxide semiconductor as a semiconductor. In either reconstruction, a conventional manufacturing line can be effectively utilized.

A transistor including a semiconductor containing an element belonging to Group 14 in a semiconductor film can be used, for example. Specifically, a semiconductor containing silicon can be used for a semiconductor film. For example, single crystal silicon, polysilicon, microcrystalline silicon, amorphous silicon, or the like can be used for the semiconductor film of the transistor.

Note that the temperature for forming a transistor using polysilicon as a semiconductor is lower than the temperature for forming a transistor using single crystal silicon as a semiconductor.

In addition, the transistor using polysilicon as a semiconductor has higher field-effect mobility than the transistor using amorphous silicon as a semiconductor, and therefore a pixel including the transistor using polysilicon can have a higher aperture ratio. Moreover, pixels arranged at very high resolution, a gate driver circuit, and a source driver circuit can be formed over the same substrate. As a result, the number of components included in an electronic device can be reduced.

In addition, the transistor using polysilicon as a semiconductor has higher reliability than the transistor using amorphous silicon as a semiconductor.

Alternatively, for example, a transistor including a compound semiconductor can be used. Specifically, a semiconductor containing gallium arsenide can be used in a semiconductor film.

A transistor including an organic semiconductor can also be used. Specifically, an organic semiconductor containing any of polyacenes and graphene can be used in the semiconductor film.

A transistor including an oxide semiconductor in a semiconductor film can also be used, for example. Specifically, an oxide semiconductor containing indium or an oxide semiconductor containing indium, gallium, and zinc can be used for a semiconductor film. An example of an oxide semiconductor will be described later in Embodiment 4.

A transistor having a lower leakage current in an off state than a transistor that uses amorphous silicon in a semiconductor film can be used, for example. Specifically, a transistor that uses an oxide semiconductor in a semiconductor film can be used.

This enables a pixel circuit including such a transistor to hold an image signal for a longer time than a pixel circuit including a transistor that uses amorphous silicon in a semiconductor film. Specifically, a selection signal can be supplied at a frequency of lower than 30 Hz, preferably lower than 1 Hz, further preferably less than once per minute while flickering is suppressed. Consequently, eyestrain on a user of a data processing device can be reduced, and power consumption for driving can be reduced.

A transistor including a semiconductor film 508, a conductive film 504, the conductive film 512A, and the conductive film 512B can be used as the switch SW1, for example (see FIG. 11B). Note that the insulating film 506 includes a region sandwiched between the semiconductor film 508 and the conductive film 504.

The conductive film 504 includes a region overlapping with the semiconductor film 508. The conductive film 504 has a function of a gate electrode. The insulating film 506 has a function of a gate insulating film.

The conductive film 512A and the conductive film 512B are electrically connected to the semiconductor film 508. The conductive film 512A has one of a function of a source electrode and a function of a drain electrode, and the conductive film 512B has the other.

A transistor including the conductive film 524 can be used as the transistor in the driver circuit or the pixel circuit (see FIG. 10B). The semiconductor film 508 is sandwiched between the conductive film 504 and a region of the conductive film 524. The insulating film 516 includes a region sandwiched between the conductive film 524 and the semiconductor film 508. The conductive film 524 is electrically connected to a wiring that supplies the same potential as that supplied to the conductive film 504, for example.

A conductive film in which a 10-nm-thick film containing tantalum and nitrogen and a 300-nm-thick film containing copper are stacked in this order can be used as the conductive film 504, for example. The film containing tantalum and nitrogen is sandwiched between the insulating film 506 and a region of the film containing copper.

A material in which a 400-nm-thick film containing silicon and nitrogen and a 200-nm-thick film containing silicon, oxygen, and nitrogen are stacked can be used for the insulating film 506, for example. The film containing silicon, oxygen, and nitrogen is sandwiched between the semiconductor film 508 and a region of the film containing silicon and nitrogen.

A 25-nm-thick film containing indium, gallium, and zinc can be used as the semiconductor film 508, for example.

A conductive film in which a 50-nm-thick film containing tungsten, a 400-nm-thick film containing aluminum, and a 100-nm-thick film containing titanium are stacked in this order can be used as the conductive film 512A or the conductive film 512B, for example. The film containing tungsten includes a region in contact with the semiconductor film 508.

### <<Input Portion 240>>

The input portion 240 includes the sensor region 241, an oscillator circuit OSC, and a sensor circuit DC (see FIG. 8).

The sensor region 241 includes one group of sensor elements 775(g,1) to 775(g,q) and another group of sensor elements 775(1,h) to 775(p,h) (see FIG. 8). Note that g is an integer greater than or equal to 1 and less than or equal top, h is an integer greater than or equal to 1 and less than or equal to q, and p and q are each an integer greater than or equal to 1.

The one group of the sensor elements 775(g,1) to 775(g,q) include the sensor element 775(g,h) and are arranged in the row direction (the direction indicated by the arrow R2 in the drawing). Note that the direction indicated by the arrow R2 in FIG. 8 may be the same as or different from the direction indicated by the arrow R1 in FIG. 8.

The another group of sensor elements 775(1,h) to 775(p,h) include the sensor element 775(g,h) and are arranged in the column direction (the direction indicated by the arrow C2 in the drawing) that intersects the row direction.

The one group of sensor elements 775(g,1) to 775(g,q) arranged in the row direction include an electrode C(g) that is electrically connected to a control line CL(g) (see FIG. 9B2).

The another group of sensor elements 775(1,h) to 775(p,h) arranged in the column direction include an electrode M(h) that is electrically connected to a sensor signal line ML(h).

The control line CL(g) includes a conductive film BR(g,h) (see FIG. 10A). The conductive film BR(g,h) includes a region overlapping with the sensor signal line ML(h).

An insulating film 706 includes a region sandwiched between the sensor signal line ML(h) and the conductive film BR(g,h). Thus, a short circuit between the sensor signal line ML(h) and the conductive film BR(g,h) can be prevented.

<<Sensor Element 775(g,h)>>

The sensor element 775(g,h) is electrically connected to the control line CL(g) and the sensor signal line ML(h).

The sensor element 775(g,h) has a light-transmitting property. The sensor element 775(g,h) includes the electrode C(g) and the electrode M(h).

A conductive film having an opening at a region overlapping with the pixel 702(i,j), for example, can be used for the electrodes C(g) and M(h). Accordingly, an object that comes in the vicinity of a region overlapping with the input/output panel 700TP can be sensed without disturbing display of the input/output panel 700TP. As a result, the visibility and operational reliability of the input/output panel 700TP can be improved.

The electrode C(g) is electrically connected to the control line CL(g).

The electrode M(h) is electrically connected to the sensor signal line ML(h) and is positioned so that an electric field part of which is blocked by an object approaching a region overlapping with the input/output panel 700TP is generated between the electrode M(h) and the electrode C(g).

The control line CL(g) has a function of supplying a control signal.

The sensor signal line ML(h) has a function of receiving the sensor signal.

The sensor element 775(g,h) has a function of supplying a sensor signal that changes in accordance with a control signal and a distance from an object approaching the region overlapping with the input/output panel 700TP.

Thus, the object approaching the region overlapping with the display device can be sensed while the data is displayed by the display device. As a result, the data processing device can process display data by the method described in Embodiment 1, whereby the operability and operational reliability of the data processing device can be improved. In addition, the variety of operations of the data processing device can be increased.

### <<Oscillator Circuit OSC>>

The oscillator circuit OSC is electrically connected to the control line CL(g) and has a function of supplying a control signal. For example, a rectangular wave, a sawtooth wave, a triangular wave, or the like can be used as the control signal.

### <<Sensor Circuit DC>>

The sensor circuit DC is electrically connected to the sensor signal line ML(h) and has a function of supplying a sensor signal on the basis of a change in the potential of the sensor signal line ML(h). Note that the sensor signal includes the positional data P1, for example.

### <<Input Portion 240>>

The input portion 240 includes a functional layer 720.

### <<Functional Layer 720>>

The functional layer 720 includes a region surrounded by the substrate 770, the insulating film 771, and the sealant 705, for example (see FIG. 10A).

The functional layer 720 includes the control line CL(g), the sensor signal line ML(h), and the sensor element 775(g,h), for example (see FIG. 9B2 and FIG. 10A).

The gap between the control line CL(g) and the second electrode 752 or between the sensor signal line ML(h) and the second electrode 752 is greater than or equal to 0.2 μm and less than or equal to 16 μm, preferably greater than or equal to 1 μm and less than or equal to 8 μm, further preferably greater than or equal to 2.5 μm and less than or equal to 4 μm.

### <<Conductive Film 511D>>

The input/output panel 700TP described in this embodiment includes the conductive film 511D (see FIG. 11A).

Note that the conductive material CP or the like can be provided between the control line CL(g) and the conductive film 511D to electrically connect the control line CL(g) and the conductive film 511D. Alternatively, the conductive material CP or the like can be provided between the sensor signal line ML(h) and the conductive film 511D to electrically connect the sensor signal line ML(h) and the conductive film 511D. A material that can be used for the wiring or the like can be used for the conductive film 511D, for example.

A material that can be used for the wiring or the like can be used for the terminal 519D, for example. Specifically, the terminal 519D can have the same structure as the terminal 519B or the terminal 519C (see FIG. 11A).

Note that the terminal 519D can be electrically connected to the flexible printed circuit FPC2 using the conductive material ACF2, for example. Thus, a control signal can be supplied to the control line CL(g) with use of the terminal 519D, for example. Alternatively, a sensor signal can be supplied from the sensor signal line ML(h) with use of the terminal 519D.

### <<Method for Processing Display Data>>

Next, a display method using the data processing device 200 described in this embodiment will be explained.

When data is displayed using a predetermined mode or a predetermined display method, the predetermined mode determines a mode for displaying the data, and the predetermined display method determines a method for displaying the data. When the data V1 and the data V2 are displayed, for example, the predetermined mode or the predetermined display method can be used.

A method for displaying the data V1 can be associated with a first mode or a second mode, for example. A method for displaying the data V2 can be associated with the first mode or the second mode. Thus, a display mode can be selected on the basis of the selected mode in each of the first display element and the second display element.

For example, three different methods for displaying the data V1 can be associated with a first display method to a third display method. Three different methods for displaying the data V2 can be associated with the first display method to the third display method. Thus, display can be performed on the basis of the selected display method in each of the first display element and the second display element.

### <<First Mode>>

Specifically, a method of supplying selection signals to a scan line at a frequency of 30 Hz or more, preferably 60 Hz or more, and displaying an image in accordance with the selection signals can be associated with the first mode.

For example, the supply of selection signals at a frequency of 30 Hz or more, preferably 60 Hz or more, can display a smooth moving image.

For example, an image is refreshed at a frequency of 30 Hz or more and preferably 60 Hz or more, so that an image smoothly following the user's operation can be displayed on the data processing device 200 the user is operating.

### <<Second Mode>>

Specifically, a method of supplying selection signals to a scan line at a frequency less than 30 Hz, preferably less than 1 Hz, further preferably less than once a minute and displaying an image in accordance with the selection signals can be associated with the second mode.

The supply of selection signals at a frequency of less than 30 Hz, preferably less than 1 Hz, further preferably less than once a minute, enables an image to be displayed with flickers reduced. Furthermore, power consumption can be reduced.

For example, when the data processing device 200 is used for a clock or watch, the display can be refreshed at a frequency of once a second, once a minute, or the like.

When a light-emitting element is used as the second display element, for example, the light-emitting element can be configured to emit light in a pulsed manner so as to display data. Specifically, an organic EL element can be configured to emit light in a pulsed manner, and its afterglow can be used for display. The organic EL element has excellent frequency characteristics; thus, time for driving the light-emitting element can be shortened, and thus power consumption can be reduced in some cases. Heat generation can be inhibited, and thus the deterioration of the light-emitting element can be suppressed in some cases.

### <<First Display Method>>

Specifically, a method in which the first display element 750(i,j) is used to display image data can be used as the first display method. Thus, for example, the power consumption can be reduced, and data with high contrast can be displayed well in a bright environment.

### <<Second Display Method>>

Specifically, a method in which the second display element 550(i,j) is used to display image data can be used as the second display method. Thus, for example, an image can be displayed well in a dark environment. A photograph and the like can be displayed with excellent color reproducibility. A moving image with quick movements can be displayed smoothly.

When the data V1 is displayed using the second display element 550(i,j), brightness for displaying the data V1 can be determined on the basis of illuminance data. For example, when illuminance is higher than or equal to 5,000 lux and less than 100,000 lux, the data V1 is displayed using the second display element 550(i,j) to be brighter than the case where the illuminance is less than 5,000 lux.

### <<Third Display Method>>

Specifically, a method in which the first display element 750(i,j) and the second display element 550(i,j) are used to display image data can be used as the third display method. In this way, power consumption can be reduced. An image can be displayed well in a dark environment. A photograph and the like can be displayed with excellent color reproducibility. A moving image with quick movements can be displayed smoothly.

A function of adjusting the brightness of display by using the first display element 750(i,j) and the second display element 550(i,j) for display can be referred to as a light adjusting function. For example, the brightness of a reflective display element can be compensated using the display element having a function of emitting light.

A function of adjusting the color of display by using the first display element 750(i,j) and the second display element 550(i,j) for display can be referred to as a color adjusting function. For example, the color of a reflective display element can be changed using the display element having a function of emitting light. Specifically, the use of a blue organic EL element can make a yellowish color displayed by the reflective liquid crystal element closer to white. Thus, text data can be displayed like texts printed on a plain paper, for example, and an eye-friendly display can be achieved.

The display method of the data processing device 200 can be changed in accordance with the illuminance of the environment. The illuminance of the environment where the data processing device 200 is used can be sensed using the sensor portion 250, for example. Color temperature or chromaticity of ambient light may be sensed instead of the illuminance of the environment.

Then, a display method is determined on the basis of the acquired illuminance data. For example, the first display method is selected when the illuminance is greater than or equal to the predetermined value, whereas the second display method is selected when the illuminance is less than the predetermined value. The third display method may be selected when the illuminance is within a predetermined range.

Specifically, in the case where the illuminance is greater than or equal to 100,000 lux, the first display method may be selected to be used. In the case where the illuminance is less than 5,000 lux, the second display method may be selected to be used. In the case where the illuminance is greater than or equal to 5,000 lux and less than 100,000 lux, the third display method may be selected to be used.

In the case where color temperature or chromaticity of the ambient light is sensed, the color of display may be adjusted using the second display element 550(i,j) by the third display method.

The first-status control data SS is supplied when the first display method is used, the second-status control data SS is supplied when the second display method is used, and the third-status control data SS is supplied when the third display method is used, for example.

Note that in the method 1 for processing display data which is described in Embodiment 1, the display element used for display can be changed in accordance with the data.

### <<Method for Displaying Data V1>>

The data processing device can display the data V1 on the entire surface of the display portion by using the first display element 750(i,j).

A reflective liquid crystal display element can be used as the first display element 750(i,j), for example. Furthermore, with use of the above-described second mode, for example, the data V1 can be displayed while a selection signal is supplied at a low frequency. In that case, power consumption can be reduced.

### <<Method for Displaying Data V2>>

When a pop-up window is displayed on the display portion while the data V1 is displayed on the entire surface of the display portion, the data V2 of the pop-up window can be displayed using the second display element 550(i,j).

An organic EL element can be used as the second display element 550(i,j), for example. Since an organic EL element can selectively increase the luminance, displaying the data V2 of the pop-up window with use of the organic EL element can improve the visibility of the data even when the area of the pop-up window is small. In addition, displaying the marker 120 with use of the organic EL element and displaying the text data with use of the reflective liquid crystal element, as shown in FIG. 2B, can highlight the selected region in the display portion. As a result, the visibility and operational reliability of the data processing device can be improved.

In the input/output panel described in this embodiment, a pixel circuit for driving the first display element and the second display element can be formed using a plurality of transistors included in one functional layer. In addition, the first display element is provided on one side of the functional layer and the second display element is provided on the other side of the functional layer. Thus, the number of members in the input/output panel can be reduced and the thickness can be smaller. As a result, a flexible data processing device can be manufactured.

Furthermore, the first display element and the second display element that uses a display method different from that of the first display element can be driven using the pixel circuit. Specifically, a reflective display element is used as the first display element, whereby the power consumption can be reduced, and an image with high contrast can be displayed well in an environment with bright external light. In addition, with use of the second display element which emits light, an image can be displayed well in a dark environment. As a result, the operability and operational reliability of the data processing device can be improved. In addition, the visibility can be enhanced and the power consumption can be reduced.

Note that this embodiment can be combined with any of the other embodiments in this specification as appropriate.

### Embodiment 3

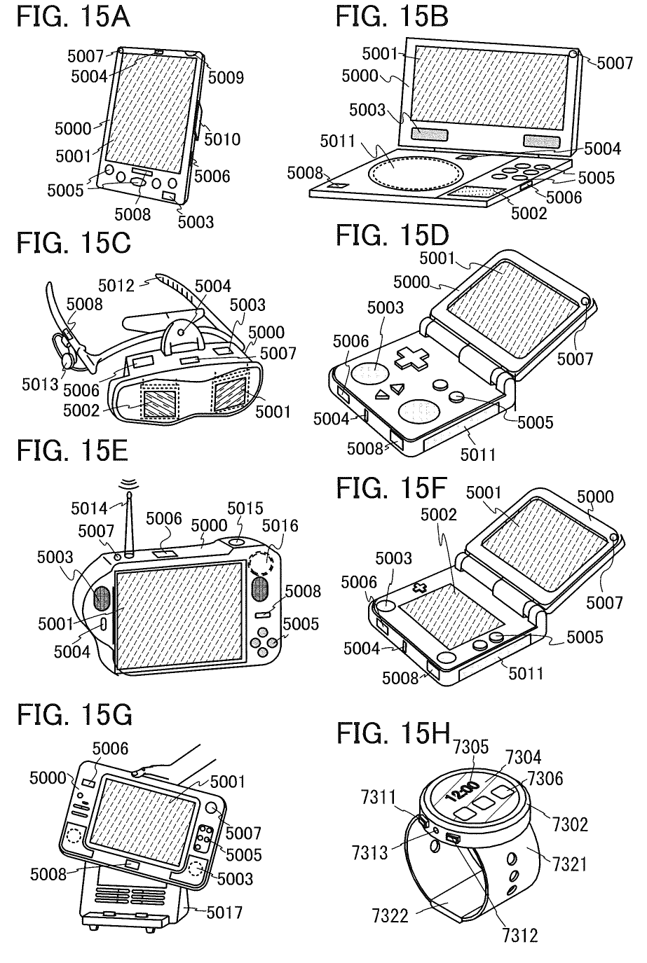

In this embodiment, electronic devices including the data processing device of one embodiment of the present invention will be described with reference to FIGS. 15A to 15H.

FIGS. 15A to 15G illustrate electronic devices. These electronic devices can include a housing 5000, a display portion 5001, a speaker 5003, an LED lamp 5004, operation keys 5005 (including a power switch or an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like.

FIG. 15A illustrates a mobile computer that can include a switch 5009, an infrared port 5010, and the like in addition to the above components. FIG. 15B illustrates a portable image reproducing device (e.g., a DVD reproducing device) provided with a recording medium, and the portable image reproducing device can include a second display portion 5002, a recording medium reading portion 5011, and the like in addition to the above components. FIG. 15C illustrates a goggle-type display that can include the second display portion 5002, a support portion 5012, an earphone 5013, and the like in addition to the above components. FIG. 15D illustrates a portable game console that can include the recording medium reading portion 5011 and the like in addition to the above components. FIG. 15E illustrates a digital camera with a television reception function, and the digital camera can include an antenna 5014, a shutter button 5015, an image receiving portion 5016, and the like in addition to the above components. FIG. 15F illustrates a portable game console that can include the second display portion 5002, the recording medium reading portion 5011, and the like in addition to the above components. FIG. 15G illustrates a portable television receiver that can include a charger 5017 capable of transmitting and receiving signals, and the like in addition to the above components.

The electronic devices illustrated in FIGS. 15A to 15G can have a variety of functions, such as a function of displaying a variety of data (a still image, a moving image, a text image, and the like) on the display portion, a touch panel function, a function of displaying a calendar, date, time, and the like, a function of controlling processing with a variety of software (programs), a wireless communication function, a function of connecting to a variety of computer networks with a wireless communication function, a function of transmitting or receiving a variety of data with a wireless communication function, and a function of reading a program or data stored in a storage medium and displaying the program or data on the display portion, for example. Furthermore, the electronic device including a plurality of display portions can have a function of displaying image data mainly on one display portion while displaying text data mainly on another display portion, a function of displaying a three-dimensional image by displaying images on a plurality of display portions with a parallax taken into account, or the like. Furthermore, the electronic device including an image receiving portion can have a function of shooting a still image, a function of taking moving images, a function of automatically or manually correcting a shot image, a function of storing a shot image in a recording medium (an external recording medium or a recording medium incorporated in the camera), a function of displaying a shot image on the display portion, or the like. Note that functions of the electronic devices in FIGS. 15A to 15G are not limited thereto, and the electronic devices can have a variety of functions.

FIG. 15H illustrates a smart watch, which includes a housing 7302, a display panel 7304, operation buttons 7311 and 7312, a connection terminal 7313, a band 7321, a clasp 7322, and the like.

The display panel 7304 mounted in the housing 7302 serving as a bezel includes a non-rectangular display region. The display panel 7304 may have a rectangular display region. The display panel 7304 can display an icon 7305 indicating time, another icon 7306, and the like.

The smart watch in FIG. 15H can have a variety of functions such as a function of displaying a variety of data (a still image, a moving image, a text image, and the like) on the display portion, a touch panel function, a function of displaying a calendar, date, time, and the like, a function of controlling processing with a variety of software (programs), a wireless communication function, a function of connecting to a variety of computer networks with a wireless communication function, a function of transmitting or receiving a variety of data with a wireless communication function, and a function of reading a program or data stored in a storage medium and displaying the program or data on the display portion, for example.

The housing 7302 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the smart watch can be manufactured using the light-emitting element for the display panel 7304.

Note that this embodiment can be combined with any of the other embodiments in this specification as appropriate.

### Embodiment 4

### <Composition of CAC-OS>

In this embodiment, described below is the composition of a cloud-aligned composite oxide semiconductor (CAC-OS) which can be used for a transistor disclosed in one embodiment of the present invention.

The CAC-OS has, for example, a composition in which elements included in an oxide semiconductor are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of an oxide semiconductor, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that an oxide semiconductor preferably contains at least indium. In particular, indium and zinc are preferably contained. In addition, one or more of aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{X2}, where X2, Y2, and Z2 are real numbers greater than 0), and gallium oxide (GaO_{X3}, where X3 is a real number greater than 0) or gallium zinc oxide (Ga_{X4}Zn_{Y4}O_{X4}, where X4, Y4, and Z4 are real numbers greater than 0), and a mosaic pattern is formed. Then, InO_{X1} or In_{X2}Zn_{T2}O_{X2} forming the mosaic pattern is evenly distributed in the film. This composition is also referred to as a cloud-like composition.

That is, the CAC-OS is a composite oxide semiconductor with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region is described as having higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≦x0≦1; m0 is a given number).

The above crystalline compounds have a single crystal structure, a polycrystalline structure, or a c-axis-aligned crystalline (CAAC) structure. Note that the CAAC structure is a crystal structure in which a plurality of IGZO nanocrystals have c-axis alignment and are connected in the a-b plane direction without alignment.

The CAC-OS relates to the material composition of an oxide semiconductor. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Thus, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected element(s) as a main component(s) are observed in part of the CAC-OS and nanoparticle regions including In as a main component are observed in part of the CAC-OS, and these nanoparticle regions are randomly dispersed to form a mosaic pattern in the CAC-OS.

The CAC-OS can be formed by a sputtering method under a condition where a substrate is not heated intentionally, for example. In the case where the CAC-OS is formed by a sputtering method, one or more of an inert gas (typically, argon), an oxygen gas, and a nitrogen gas may be used as a deposition gas. The flow rate of the oxygen gas to the total flow rate of the deposition gas in deposition is preferably as low as possible, for example, the flow rate of the oxygen gas is higher than or equal to 0% and lower than 30%, preferably higher than or equal to 0% and lower than or equal to 10%.

The CAC-OS is characterized in that a clear peak is not observed when measurement is conducted using a θ/2θ scan by an out-of-plane method with an X-ray diffraction (XRD). That is, it is found by the XRD that there are no alignment in the a-b plane direction and no alignment in the c-axis direction in the measured areas.

In the CAC-OS, an electron diffraction pattern that is obtained by irradiation with an electron beam with a probe diameter of 1 nm (also referred to as nanobeam electron beam) has regions with high luminance in a ring pattern and a plurality of bright spots appear in the ring-like pattern. Thus, it is found from the electron diffraction pattern that the crystal structure of the CAC-OS includes a nanocrystalline (nc) structure that does not show alignment in the plane direction and the cross-sectional direction.

For example, energy dispersive X-ray spectroscopy (EDX) is used to obtain EDX mapping, and according to the EDX mapping, the CAC-OS of the In—Ga—Zn oxide has a composition in which the regions including GaO_{X3} as a main component and the regions including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{V2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is generated. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used in a semiconductor element, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

A semiconductor element including a CAC-OS has high reliability. Thus, the CAC-OS is suitably used in a variety of semiconductor devices typified by a display.

At least part of this embodiment can be implemented in combination with any of the other embodiments described in this specification as appropriate.

In this specification and the like, an explicit description “X and Y are connected” means that X and Y are electrically connected, X and Y are functionally connected, and X and Y are directly connected, for example. Accordingly, without being limited to a predetermined connection relationship, for example, a connection relationship shown in drawings or texts, another connection relationship is included in the drawings or the texts.

Here, each of X and Y denotes an object (e.g., a device, an element, a circuit, a wiring, an electrode, a terminal, a conductive film, or a layer).

Examples of the case where X and Y are directly connected include the case where an element that enables electrical connection between X and Y (e.g., a switch, a transistor, a capacitor, an inductor, a resistor, a diode, a display element, a light-emitting element, or a load) is not connected between X and Y, and the case where X and Y are connected without the element that enables electrical connection between X and Y provided therebetween.

In the case where X and Y are electrically connected, one or more elements that enable electrical connection between X and Y (e.g., a switch, a transistor, a capacitor, an inductor, a resistor, a diode, a display element, a light-emitting element, or a load) can be connected between X and Y, for example. Note that the switch is controlled to be turned on or off. That is, the switch is conducting or not conducting (is turned on or off) to determine whether current flows therethrough or not. Alternatively, the switch has a function of selecting and changing a current path. Note that the case where X and Y are electrically connected includes the case where X and Y are directly connected.

In the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up circuit or a step-down circuit) or a level shifter circuit for changing the potential level of a signal; a voltage source; a current source; a switching circuit; an amplifier circuit such as a circuit capable of increasing signal amplitude, the amount of current, or the like, an operational amplifier, a differential amplifier circuit, a source follower circuit, and a buffer circuit; a signal generator circuit; a memory circuit; and/or a control circuit) can be connected between X and Y, for example. Note that, in the case where a signal output from X is transmitted to Y even when another circuit is provided between X and Y, for example, X and Y are functionally connected. The case where X and Y are functionally connected includes the case where X and Y are directly connected and X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the explicit description “X and Y are connected.”

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

Examples of the expressions include, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path” and “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path”. Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit structure is defined by an expression similar to the above examples, a source (or a first terminal or the like) and a drain (or a second terminal or the like) of a transistor can be distinguished from each other to specify the technical scope.

Note that these expressions are examples and there is no limitation on the expressions. Here, X, Y, Z1, and Z2 each denote an object (e.g., a device, an element, a circuit, a wiring, an electrode, a terminal, a conductive film, or a layer).

Even when independent components are electrically connected to each other in a circuit diagram, one component has functions of two or more components in some cases. For example, when part of a wiring also functions as an electrode, one conductive film functions as the wiring and the electrode. Thus, the term “electrical connection” in this specification also means such a case where one conductive film has functions of two or more components.

### REFERENCE NUMERALS

ACF1: conductive material, ACF2: conductive material, AF1: alignment film, AF2: alignment film, B0: copy process, C0: cut process, C1: arrow, C2: arrow, C11: capacitor, C12: capacitor, CF1: coloring film, CF2: coloring film, D0: paste process, G1: scan line, G2: scan line, KB1: structure body, P1: positional data, R1: arrow, R2: arrow, S2: signal line, SD1: driver circuit, SD2: driver circuit, SW1: switch, SW2: switch, V1: data, V2: data, VCOM1: wiring, VCOM2: conductive film, X1-X2: line, X3-X4: line, X5-X6: line, X7-X8: line, X9-X10: line, X11-X12: line, 102: display portion, 110: forefinger, 112: middle finger, 120: marker, 130: region, 200: data processing device, 210: arithmetic device, 211: arithmetic portion, 212: memory portion, 214: transmission path, 215: input/output interface, 220: input/output device, 230: display portion, 231: display region, 238: control portion, 240: input portion, 241: sensor region, 250: sensor portion, 290: communication portion, 501A: insulating film, 501C: insulating film, 504: conductive film, 505: bonding layer, 506: insulating film, 508: semiconductor film, 511B: conductive film, 511C: conductive film, 511D: conductive film, 512A: conductive film, 512B: conductive film, 516: insulating film, 518: insulating film, 519B: terminal, 519C: terminal, 519D: terminal, 520: functional layer, 521: insulating film, 522: connection portion, 524: conductive film, 528: insulating film, 530: pixel circuit, 550: display element, 551: electrode, 552: electrode, 553: layer, 570: substrate, 591A: opening, 591B: opening, 591D: opening, 592A: opening, 592B: opening, 592D: opening, 700TP: input/output panel, 702, pixel, 705: sealant, 706: insulating film, 719: terminal, 720: functional layer, 750: display element, 751: electrode, 751E: region, 751H: opening, 752: electrode, 753: layer, 754A: intermediate film, 754B: intermediate film, 754C: intermediate film, 754D: intermediate film, 770: substrate, 770D: functional film, 770P: functional film, 771: insulating film, 775: sensor element, 5000: housing, 5001: display portion, 5002: display portion, 5003: speaker, 5004: LED lamp, 5005: operation key, 5006: connection terminal, 5007: sensor, 5008: microphone, 5009: switch, 5010: infrared port, 5011: record medium reading portion, 5012: support portion, 5013: earphone, 5014: antenna, 5015: shutter button, 5016: image receiving portion, 5017: charger, 7302: housing, 7304: display panel, 7305: icon, 7306: icon, 7311: operation button, 7312: operation button, 7313: connection terminal, 7321: band, 7322: clasp

This application is based on Japanese Patent Application Serial No. 2016-111951 filed with Japan Patent Office on Jun. 3, 2016, the entire contents of which are hereby incorporated by reference.

1. A data processing device comprising:
a display portion;
an input portion;
an arithmetic portion; and
a memory portion,
wherein the input portion is configured to detect a first contact point and a second contact point, and to detect a first path of the second contact point when the second contact point moves while the first contact point is fixed,
wherein the arithmetic portion is configured to store, in the memory portion, data displayed on a region of the display portion where the first path is detected,
wherein the input portion is configured to detect a third contact point and a fourth contact point after detecting the first path, and to detect a second path of the fourth contact point when the fourth contact point moves while the third contact point is fixed, and
wherein the arithmetic portion is configured to paste the data stored in the memory portion on a region where the second path is detected.

2. A data processing device comprising:
a display portion;
an input portion;
an arithmetic portion; and
a memory portion,
wherein the input portion is configured to detect a first contact point and a second contact point, and to detect a first path of the second contact point when the second contact point moves while the first contact point is fixed,
wherein the arithmetic portion is configured to display a first pop-up window near the first path on the display portion,
wherein the input portion is configured to detect a contact point on the first pop-up window,
wherein the arithmetic portion is configured to store, in the memory portion, data displayed on a region where the first path is detected, in accordance with data selected by the contact point on the first pop-up window,
wherein the arithmetic portion is configured to close the first pop-up window on the display portion,
wherein the input portion is configured to detect a third contact point and a fourth contact point after detecting the first path, and to detect a second path of the fourth contact point when the fourth contact point moves while the third contact point is fixed,
wherein the arithmetic portion is configured to display a second pop-up window near the second path on the display portion,
wherein the input portion is configured to detect a contact point on the second pop-up window,
wherein the arithmetic portion is configured to paste the data stored in the memory portion on a region where the second path is detected, in accordance with data selected by the contact point on the second pop-up window, and
wherein the arithmetic portion is configured to close the second pop-up window on the display portion.

3. The data processing device according to claim 2,
wherein the display portion comprises a first display element and a second display element,
wherein the first display element is a reflective liquid crystal element,
wherein the second display element is a light-emitting element, and
wherein the second display element displays the first pop-up window and the second pop-up window.

4. The data processing device according to claim 1, wherein the input portion is a touch panel.

5. The data processing device according to claim 2, wherein the input portion is a touch panel.

6. A display method of a data processing device, comprising:
a first step of detecting a first contact point and a second contact point;
a second step of detecting a first path of the second contact point when the second contact point moves while the first contact point is fixed;
a third step of displaying a first pop-up window near a region where the first path is detected;
a fourth step of detecting a contact point on the first pop-up window;
a fifth step of storing, in a memory portion, data displayed on the region where the first path is detected, in accordance with data selected by the contact point on the first pop-up window;
a sixth step of detecting a third contact point and a fourth contact point;
a seventh step of detecting a second path of the fourth contact point when the fourth contact point moves while the third contact point is fixed;
an eighth step of displaying a second pop-up window near the second path;
a ninth step of detecting a contact point on the second pop-up window; and
a tenth step of pasting the data on a region where the second path is detected, in accordance with data selected by the contact point on the second pop-up window.
